(19) United States
(12) Patent Application Publication
(10) Pub. No.: US 2012/0043196 A1
(43) Pub. Date: Feb. 23, 2012

(54) VERSATILE DISTILLATION CELL

(76) Inventor: Diderot De Arruda Aniz, Sao Paulo, SP (BR)

(21) Appl. No.: 13/318,873

(22) PCT Filed: May 8, 2009
(86) PCT No.: PCT/IB2009/051916

§ 371 Date: Nov. 4, 2011

(51) Int. Cl. B01D 3/32

(52) U.S. Cl. 202/158

(57) ABSTRACT

The Versatile Distillation Cell introduces and extends technical resources of the “Flexible Manufacturing Cell” (set of multifunctional integrated machines with flexible, quick interchangeable tools) in distillation systems of mobile, modular, interchangeable columns with internals (trays and others) fitted with variable form and position. Rapid structural change of mobile columns and variable control of liquid-vapour ratio in internals are integrated, enabling quick on site process diversification and adjustment with easy relocation.

The Versatile Distillation Cell introduces and extends technical resources of the “Flexible Manufacturing Cell” (set of multifunctional integrated machines with flexible, easily interchangeable tools—already usual in several industries) in systems of mobile, modular, interchangeable distillation columns with internals (trays and others) fitted with variable geometry and positioning. Rapid structural change of mobile columns and variable control of liquid-vapor ratio in internals are integrated—thus enabling quick on site process diversification and adjustment with easy relocation.

The Cell (1) consists of a integrated set of functional sub-cells (100, 127, 200, 204, 207) comprising distillation columns (103 to 106, 125, 216 to 218), that can be composed of articulable modules (107 a 109, 114, 205, 206, 208 a 210), and can be on mobile platforms (119, 120,201) horizontally transported by road or other way, assembled, exchanged and vertically elevated for a distillation process, which is modifiable and adjustable, in real or quick process time, by variable liquid-vapor ratio control in internal column's components (301 a 360) of sets (1000 a 1015) fitted with variable form and positioning in: perforate tray with variable inclination (1000); foldable, perforated double tray (1001); concentric gyratory perforated tray (1002); variable control of opening of a bubble-cap or valve by solenoid (1003); variable control by iris diaphragm of individual holes and of the perforation of a tray (1004, 1005); variable control by pantographic retractile grid of individual holes and of the perforation of a tray (1006,1007); variable control of distance between trays and packings moving shaft (1008, 1009); magazine for quick changeover of trays (1010) and packings (1011); flexible distribution net for variable sparging flow of micro- or nanobubbles in trays (1012), as well as in packings, reflux inlet, liquid distributors and collectors (1013), and variable height control of downcomer's weirs (1014, 1015). After a distillation the sub-cells can lower columns, disassemble, reassemble and exchange columns, modules and internals for another local or relocated operation.

Prior Art, Limitations and New Demands

Distillation columns in chemical, oil, gas, bio-fuel, food, perfumes and other industries are in general designed for processing specific raw materials and final products. The aim is specialization and scale in continuous as well in discontinuous distillation processes. As such, distillation columns currently are immobile constructions on the soil of the industrial plant; the height and form of columns bodies are fixed as they depend on the numbers and spacing of the columns internals (trays, packings and others) that are rigidly build in for performing under the same distillation parameters during decades of a column lifetime.

Disadvantages of fixed and rigid columns are known: difficult transport, repair and maintenance; complicate process adjustments and informational control compared with other industries; process changes need often deep restructuring; interventions in one column can hinder entire systems or arrangements of columns in a plant; long lead time changes or adjustments increase waste of energy and other resources, and exclude several products and sub-products from profitable processing, among others.

Presently, new demands for versatile distillation seem to emerge: geographically decentralized agriculture and forestry, favoring policulture instead of large monoculture, offer diversified distillation materials, often distant from industrial plants; in chemical, perfume, food and other industries that use distillation, the interest is growing for customized, higher value differentiated products in smaller volume; environment sustainability demands more and more equipments that can treat diverse and dispersed distillable waste and pollutants.

Responding to these new demands, mini-refineries for ethanol and bio-diesel and small waste recycling facilities focus decentralized operations distant from the big industries, but remain specialized, fixed and rigidly constructed. Existing portable columns for distilling small quantities of water, wood, fragrances and oils are in general vertically placed on a vehicle—being the height an important transport restriction—and their external and internal construction remain rigid and specialized. These are not versatile, but only small, movable columns Rigidity, as a restriction to variable processing, remains a characteristic in hitherto presented improvements of trays, packings and other internals, aiming to optimization of the liquid-vapor ratio in distillation columns For instance, it is known that the micro- and nano-bubbles sparging process, today used in various industries, can enhance mass transfer yield (smaller vapor bubbles increase the contact area with liquid). However, the state of the art doesn't include a flexible distribution net of distillation vapor sparging in columns internals for variable control of the vapor-liquid ratio and enhanced mass transfer yield in diversified distillation processes, as here proposed.

As mentioned, flexible equipments are already adopted by industries other than distillation, as automotive, metalurgy, electronic etc. Particularly the “Flexible Mnufacturing Cell”—a set of multifunctional integrated machines, with easily intercheangeable components and tools fitted with variable geometry and position—combines SMED (Single Minute Exchange of Die and Tools), automation and “lean production” in todays' “agile production”, partially inspiring this invention.

### INVENTION PROPOSAL AND OBJECTIVES

The invention aims to create versatility, as a combination of equipments flexibility, inspired in the “Flexible Manufacturing Cell”, by introducing real time variable geometry and positioning in trays and other internal components of distillation, with mobility and quick inter-exchangeability of modular column's systems and columns internals on a platform. The main objective is to enable quick diversification, real time adjustments and rapid relocation of distillation processes.

This objective is obtained by accumulating efficiency advantages of flexibility in partial innovations that can impact: every point in a tray or other internals where bubbling, or mass transfer, occurs; the whole set of such points in an internal column component; the components set of a column; the columns body form and dimensions; and a columns arrangement or sequential system in a distillation process.

Such partial innovations are integrated and reciprocally inter-conditioned: it would be of little use to fit an immobile, scale processing column with quick changeable and flexible internals. Nor it would be feasible to move several rigid columns to distant, temporary, diversified services.

These proposed partial innovations aim mainly to attain:
Modular, articulable column structure for easy horizontal transport and vertical operation over a mobile platform;
Easy modules aligning and fixing, with rapid column vertical elevation;
Rapid exchange of modules and columns at origin and destination, before and after a process, enabling variable distillation systems according to clients local needs;
Rapid exchange of internals before, after or during brief paused distillation;
Variable geometry and positioning of column internals for variable control and adjustment of the vapor-liquid ratio, in real or quick distillation process time;
Rapid lowering, disassembling and exchange of columns, modules and internals for depart and relocation;

### INVENTION DEFINITION

The Versatile Distillation Cell introduces in distillation systems, applicable in several industries (bio-fuel, chemical, oil, gas, waste recovery and others) some technological resources inspired in the “Flexible Manufacturing Cell” (operational integrated set of multifunctional machines with flexible, interchangeable tools and parts), adding the easy transportability, modular interchangeability and distillation processing over mobile platforms—aiming to quick process diversification among distillable materials, final products and processing sites.

The invention proposes modular columns that can be horizontally transported, assembled, filled with internals, or exchanged, and modularly modify sections of the body, being then vertically elevated for distillation processing over a mobile platform; the process is made adjustable through variable control of the liquid-vapor ratio in internals where bubbling, or mass transfer, occurs; this control is obtained in real or quick process time by introducing variable geometry and positioning in: perforate tray with variable inclination; foldable, perforated double tray; concentric gyratory perforated tray; variable control of the orifice's opening of a bubble-cap or valve by solenoid; variable control by iris diaphragm of individual holes and of the perforation of a tray; variable control by pantographic retractile grid of individual holes and of the perforation of a tray; variable control of distance between trays and packings by moving shaft; magazine for quick changeover of trays and packings; flexible distribution net for variable sparging flow of micro or nanobubbles in trays, as well as in packings, reflux inlet, liquid distributors and collectors; and variable height control of a downcomer's weir; the internals geometry and positioning variability has electromechanical conventional control, here not detailed, which can be computerized and automated.

Since materials and process diversification imply changes in columns' body forms and dimensions due to different sizes, numbers and spacing of columns' internals, the Cell can exchange and combine columns and modules of different body forms and heights, that can be filled with variable internals' sets; considering this necessary flexibility, and the columns' height restriction for mobility, the Cell combines the integrated set of partial innovations in five flexible mobile sub-cells (as in a system/subsystem or assembling/sub-assembling concept): two rotating sub-cells containing rotating devices enabling portable functioning of columns with height not exceeding the length measure of a mobile platform; and three articulated sub-cells containing articulated modules enabling columns whose height can exceed the length measure of a mobile platform. the first rotating sub-cell comprises a rotational elevatory tower on a mobile platform, carrying a variable system or array of several columns or modules, and the second rotating sub-cell comprises a rotating block on a mobile platform with elevator, carrying a modular column with a variable number of modules, that can be aligned, being this sub-cell fitted with assembling guide-tracks and transfer guide-tracks with transfer crane devices for transferring modules and columns between platforms. The first articulated sub-cell comprises a column with articulated, folded modules on a mobile platform; the second articulated sub-cell is similar to the first, but has at least one module fitted with a extend/retract telescopic movement; and the third articulated sub-cell comprises a column formed by modules surrounded by an external structure.

The in this invention proposed equipments and parts can be manufactured with known materials: metal tubes, sheets, plates wires, and profiles; stainless steel of 300 and 400 series; metal alloys and plastics resistant to pressure, temperature, and corrosion; Monel, Teflon and others.

Some conventional equipment connected with distillation columns—for instance reboiler, condenser, cooler—and platform equipments, can be mentioned to better clarify some topics. The invention presupposes that distillable materials as well as other necessary equipments—energy, hydraulic, tanks, boilers, generators etc—are rendered available in loco, by clients.

### GENERAL APPLICATIONS AND ADVANTAGES OF THE INVENTION

Among applications and advantages of the invention can be mentioned:
Distilling diverse materials in different places by quick mobility and interchangeability of columns and of flexible internals;
Successive processing of diverse products on site by quick exchangeability of columns and internals with agile process adjustment;
Simultaneous processing of diverse products on site by combining independent columns in a multicolumn sub-cell or combining various sub-cells;
Completion on site of a distillation phased process by means of sub-cell with sequential columns arrangement;
Diversified handling and recovery of waste water and other distillation wastes;
Diversified handling and recovery of distant and disperse waste and pollutants;
Distillation services rendered to producers of agricultural and forest materials not accessible to big industries, factories and refineries;
Use of local and seasonal sources of energy;
Enhanced control of energy and other resources consumption;
Distilling on production site of difficult to obtain sensible fragrances;
Making feasible to distill small, exceptional or emergency batches of materials in big industries;
Temporary operation during maintenance periods in the industry;
Value creation by “mix” of diversified final products from individually unfeasible batches;
Increasing facility in manufacturing and external and internal assembling of distillation columns by means of rotational tower and block;
Important increase in maintenance facility for columns and in internals;
Ability to interfaces of computerized and automated actuation and control systems.
Main longterm expected contribution is to descentralized and diversified competitive production in policultural agriculture, bio-diverse forestry and flexible distillation industry in a sustainable environment.

### BRIEF DESCRIPTION OF THE DRAWINGS

FIG. 1 presents an illustrative diagram of the Versatile Distillation Cell as integrating flexible internal components of modular, interchangeable distillation columns systems in 5 functional, mobile sub-cells.

FIG. 2 exemplifies 3 arrangements or systems of distillation columns: with one column (FIG. 2.1) for distilled, raw ethanol; with two columns (FIG. 2.2) for distilled and rectified ethanol; and with three columns (FIG. 2.3) for distilled, rectified and dehydrated ethanol.

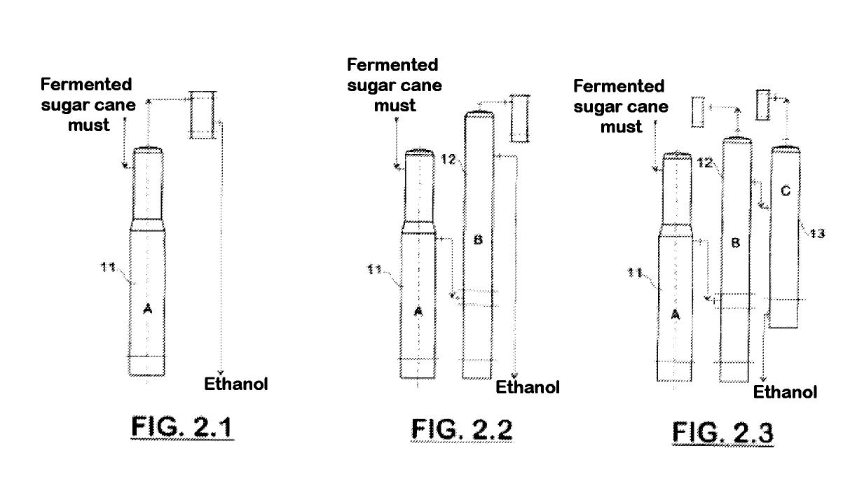

FIG. 3 illustrates a basic distillation column comprising a tube with feed vapor and reflux inlet and with basis- and top products outlets, being the column fitted with trays, packings, liquid distributors and liquid collectors.

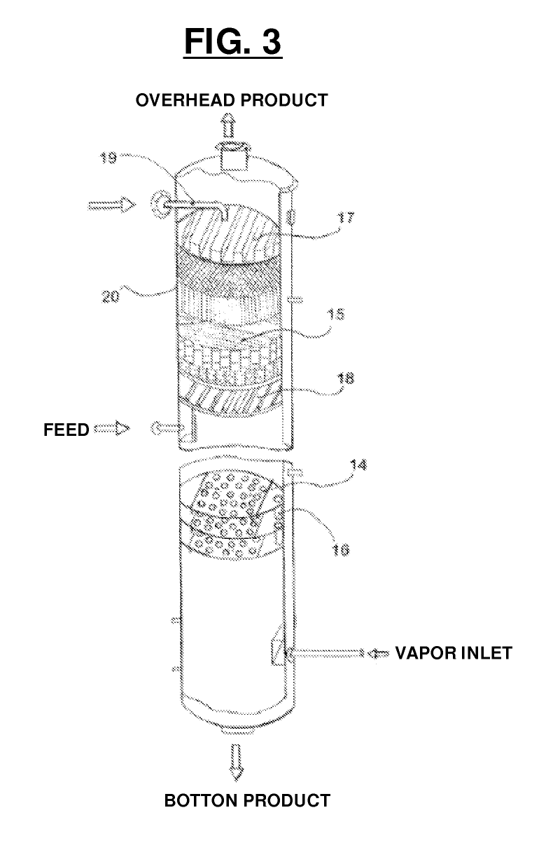

FIG. 4 exemplifies in side view (FIG. 4.1.) and in plan view (4.2.) a rotating tower with 4 columns;

FIG. 5 exemplifies in plan view the sub-cell with rotating tower with 4 columns in horizontal position on a mobile platform;

FIG. 6 exemplifies a side view of FIG. 5.

FIG. 7 exemplifies in side view the elevation of the sub-cells rotating tower with 4 columns, still attached to the elevator;

FIG. 8 exemplifies in side view the rotating tower elevated to vertical distillation position, being the elevator system retracted;

FIG. 9 exemplifies the schema of a flexible mobile sub-cell with rotating block, with one distillation column composed of 4 modules, on a mobile plataform;

FIG. 10 exemplifies in plan view a sub-cell with rotating block with one column composed of 4 modules, and a reboiler on assembling guide-tracks;

FIG. 11 exemplifies in plan view a sub-cell with rotating block aligning column modules and assembling internal components (trays, packings and others) on guide tracks, the sub-cell being also fitted with guide-tracks with a pair of crane devices for transferring modules and columns among platforms of sub-cells;

FIG. 12 exemplifies in plan view 4 aligned and locked modules forming a distillation column, including a reboiler, being the column in horizontal position over guide-tracks;

FIG. 13 exemplifies in side view the hydraulic elevator and the support pads of the platform;

FIG. 14 exemplifies in side view the elevated column to vertical position of distillation process;

FIG. 15 exemplifies in side view the sub-cell ready for operation, and the elevator retracted;

FIG. 16 exemplifies in plan view a flexible, mobile articulated sub-cell with a distillation column composed of 3 modules folded and juxtaposed on as mobile platform;

FIG. 17 exemplifies in plan view a quick assembling of internals (trays, packings and magazines) in 3 modules folded in horizontal position over a mobile platform;

FIG. 18 exemplifies a side view of FIG. 16 showing the hydraulic elevator;

FIG. 19 exemplifies in plan view the unfolding and locking of 2 modules of a column with 3 articulated modules on a mobile platform;

FIG. 20 exemplifies in plan view 3 unfolded, aligned and fixed modules forming a column in horizontal position on a mobile platform, being added to the column a condenser an a cooler;

FIG. 21 exemplifies in side view the elevation of a column composed of 3 articulated modules;

FIG. 22 exemplifies a column with 3 modules in vertical position of distillation, with a reboiler in the base, the column's top having attached a cooler and a condenses, being the elevator retracted and housed in the mobile platform;

FIG. 23 exemplifies a flexible mobile articulated sub-cell with 4 modules being 3 articulated and a 4^{th}, superior posterior module fitted with extend-retract telescopic movement;

FIG. 24 exemplifies in plan view the FIG. 23 as internals (trays, packings and magazines) are being assembled on a mobile platform;

FIG. 25 exemplifies a side view of FIGS. 23 and 24, showing the elevator of the sub-cell;

FIG. 26 exemplifies in plan view a sub-cell with unfolding column of 4 modules, being 3 modules articulated and the 4^{th}, telescopic module inserted into the 3^{rd} module, which is aligned and fixed to the 2^{nd} module;

FIG. 27 exemplifies in plan view 4 modules unfolded, aligned, and locked, in horizontal position on a mobile platform, forming a column, which has a reboiler at the base and a cooler and a condenser at the top, being the 4^{th}, superior, telescopic module extended and locked to the 3^{rd};

FIG. 28 as per FIG. 27, exemplifies in plan view the 3^{rd} and 4^{th} modules, assembled with internals as trays, packings liquid distributor, liquid collector, and magazines for quick-changeover of trays and packings, having the column a condenser and a cooper at its top;

FIG. 29 exemplifies in side view as per FIG. 27, the elevation to vertical distillation position of a column with 4 modules, being one telescopic;

FIG. 30, exemplifies in side view, as per FIG. 29, the column in final position of distillation;

FIG. 31 exemplifies in plan view a flexible mobile articulated sub-cell with 3 superposed modules surrounded by a metallic structure, on a mobile platform;

FIG. 32 presents a side view of FIG. 31, exemplifying a lift hook fixed at the top of the metal structure;

FIG. 33 exemplifies in side view the lifting of a modular column with external structure on a mobile platform;

FIG. 34 exemplifies in side view an externally structured column in vertical position of distillation having at the top a cooler and a condenser;

FIG. 35 exemplifies a gyratory, perforated tray “butterfly type” in horizontal position (FIG. 35.1, detail in FIG. 35.1.1) and in the vertical (FIG. 35.2, detail in FIG. 35.2.1);

FIG. 36 exemplifies a set of two concentric differently perforated trays, each divided in two halves, type “double bvutterfly”, being in FIG. 36.1. (section 36.1.1. and detail 36.1.2) the inferior tray with unfolded halves in the horizontal, and the superior tray with both halves upward folded in the vertical; and in FIG. 36.2 (section 36.2.1 and detail 36.2.2) being the superior tray with unfolded halves in the horizontal and the inferior tray with downward folded halves in the vertical;

FIG. 37 exemplifies a set of two concentric, superposed, equally or differently perforated trays, being the superior tray fixed and the inferior gyratory fitted with perpendicular rotating axes with motion transfer (section in FIG. 37.1 and detail FIG. 37.2);

FIG. 38 exemplifies the cross section view of a fixed bubble-cap with a mobile opening controlled by solenoid;

FIG. 39 exemplifies the application of a “iris diaphragm” (section FIG. 39.1) for variable control of a hole opening (section FIG. 39.1, detail FIG. 39.2) of a perforated tray;

FIG. 40 (side view FIG. 40.1, plan view FIG. 40.2) exemplifies the variable control by “iris diaphragm”, of he openings of a holes' set of a perforated tray;

FIG. 41 exemplifies the variable control by pantographic grid (side view FIG. 41.1, open grid FIG. 41.2, closed grid FIG. 41.3) of a hole opening of a perforated tray;

FIG. 42 exemplifies the variable control by pantographic grid (side view FIG. 42.1, open grid FIG. 42.2, closed grid FIG. 42.3) of the openings of a holes' set of a perforated tray;

FIG. 43 (side view FIG. 43.1., section FIG. 43.2, plan view FIG. 43.3) exemplifies concentric vertical axes to which trays and/or packings are attached, being the axes fitted with vertical movement enabling variable control of the distances among trays and/or packings inside of a column;

FIG. 44 (side view FIG. 44.1. and FIG. 44.2) exemplifies concentric vertical axes to which trays and/or packings are attached, being the axes fitted with vertical movement by command of horizontal axes with motion transfer, enabling variable control of the distances among trays and/or packings inside of a column;

FIG. 45 (side view FIG. 45.1; section FIG. 45.2 and plan view FIG. 45.3) exemplifies a magazine with trays encased in separated extend-retractile chambers, enabling through a sliding hatch in a column, the quick changeover of trays during brief intermittence of distillation process;

FIG. 46 (side view FIG. 46.1; plan view FIG. 46.2) exemplifies a magazine with packings encased in separated extend-retractile-turning chambers, enabling through a sliding hatch in a column, the quick changeover of packings during brief intermittence of distillation process;

FIG. 47 exemplifies in side view a flexible device for insertion, by the sparging method, of a micro- or nano-bubbles variable flow of distillable material by means of a capillary network distributed in bubbling points of a tray;

FIG. 48 exemplifies in side view (FIG. 48.1) a flexible device for insertion, by the sparging method, of a micro- or nano-bubbles variable flow of distillable material by means of a capillary network distributed in: the reflux inlet (FIG. 48.2), liquid distributor (FIG. 48.3), packing (48.4) and liquid collector (FIG. 48.5);

FIG. 49 exemplifies (side view FIG. 49.1; section FIG. 49.2 and plan view FIG. 49.3) a device for variable control of the height of a tray's or other component's downcomer fitted with a flat weir capable of vertical sliding movement by means of a gyratory axis with motion transfer;

FIG. 50 exemplifies (side view FIG. 50.1, section FIG. 50.2 and plan view FIG. 50.3) a device for variable control of the height of a tray's or other component's downcomer fitted with a tubular weir capable of vertical sliding movement by means of a gyratory axis with motion transfer.

### DETAILED INVENTION DESCRIPTION

Versatile Distillation Cell

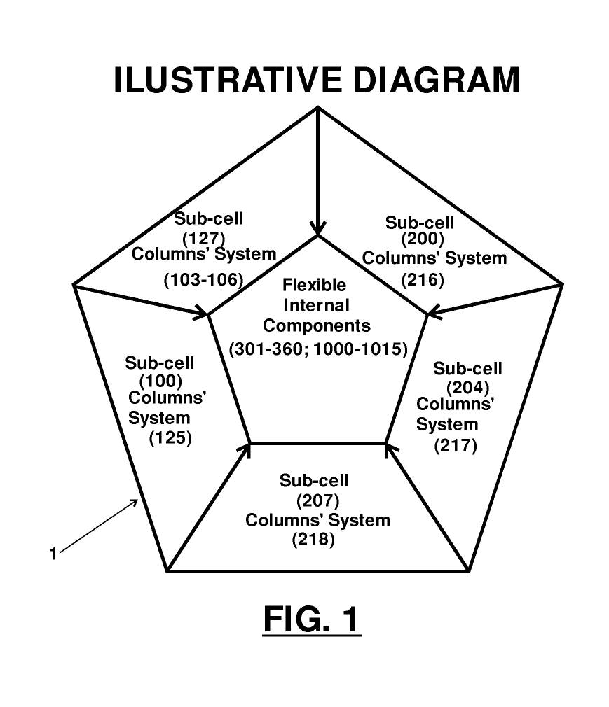

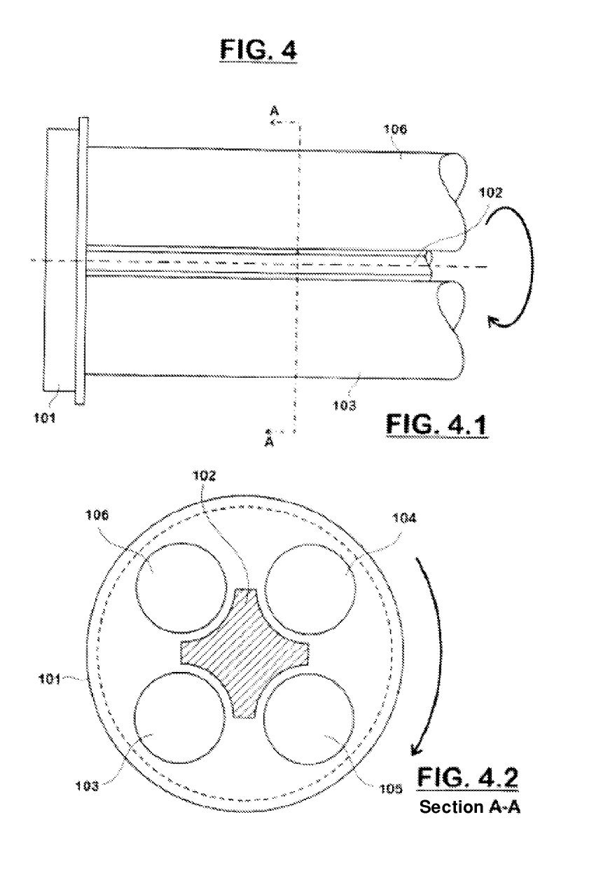

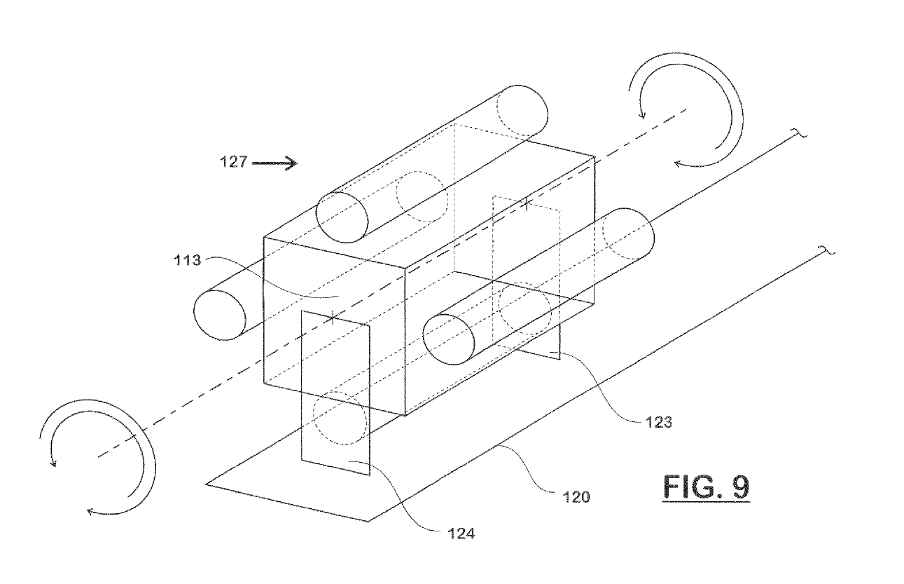

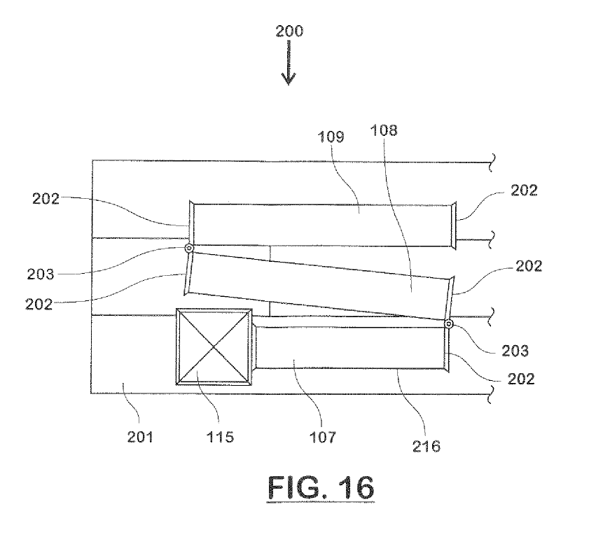

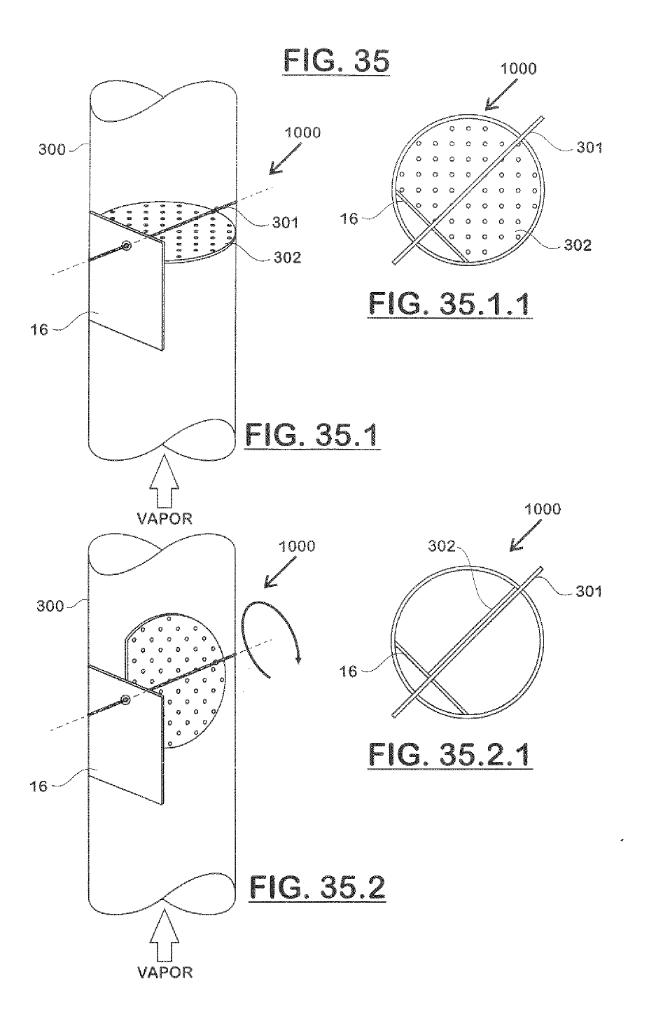

The Versatile Distillation Cell (1) (diagram shown in FIG. 1) consists of a set of equipments and devices functionally integrated and interdependent, comprising mobile and interchangeable systems of distillation columns (103 to 106, 125, 216 to 218) composed of articulated modules (107 to 109, 114, 205, 206, 208 to 210, examples in FIGS. 4 to 34) being the internal components (301 to 360) of the sets (from 1000 to 1015) fitted with variable geometry and position (examples in FIGS. 35 to 50), thus enabling diversified, quick interchangeable and adjustable distillation operations. The Cell (1) is the functional integration of five flexible mobile sub-Cells: two rotating sub-Cells (100, 127), for manufacturing, deploying, assembling, transporting and raising to the vertical distillation position columns (103 to 106, 125), whose maximum height doesn't exceed the length of a mobile platform (119, 120) (examples in FIGS. 4 to 15), where the first rotating Sub-Cell (100) is fitted with a rotational, elevatory tower (126) on a mobile platform (119), carrying a variable system or arrangement of several columns (103 to 106), (examples in FIGS. 4 to 8), and the second rotating sub-cell (127) is fitted with a rotating block (113) on a mobile platform (120) with elevator (112), carrying a modular column (125) with a variable number of modules (107 to 109, 114) that can be aligned, being said sub-cell (127) fitted with assembling guide-tracks (116), transfer guide-tracks (117) and transfer crane devices (118) for transferring modules and columns between platforms (119, 120, 201) (examples in FIGS. 9 to 15); and three flexible mobile, articulated sub-cells (200, 204, 207), each carrying one column (216 to 218) whose height can exceed the measure of the length of a mobile platform (201), each of said columns being composed of a variable number of articulated modules (107 to 109, 205, 206, 208 to 210), where: the first articulated sub-cell (200) is fitted with a column (216) with articulated, folded modules (107 to 109), the second articulated sub-cell (204) is fitted with a column (217) with articulated modules (107, 108, 205, 206) except at least one, which has a telescopic extend/retract movement (206), and the third articulated sub-cell (207) comprises a column (218) formed by modules (208 to 210) surrounded by an external structure (examples in FIGS. 16 to 34).

Before and after a distillation operation, as it will be detailed, sub-cells (100, 127, 200, 204, 207) can exchange among themselves columns and modules, by activating said sub-cell (127) with rotating block (113), assembling guide-tracks (116), transfer guide-tracks (117) and transfer devices (118) for modules (107 a 109, 114, 205, 206, 208 a 210) and columns (103 a 106, 125, 216 a 218) between platforms (119, 120, 201).

Before and after operation, the assembling and exchange of internal column components (301 to 360) of sets (1000 to 1015), such as trays (14, 302, 304, 305, 306, 307, 310, 315, 319, 323, 327, 331, 334, 344, 356, 359), packings (15, 330, 343, 353), distributors (17, 352), collectors (18, 354) and others, can be performed through modules' extremities (107 to 109) and by means of magazines for quick changeover of trays (340 and of packings (342). Other connected equipments can also be attached, for example reboiler (115), condenser (121), and cooler (122).

During operation, real or quick time variable control of vapor-liquid ratio is obtained by: perforate tray with variable inclination (1000); foldable, perforated double tray (1001); concentric gyratory perforated tray (1002); variable opening of a bubble-cap or valve by solenoid (1003); variable control by iris diaphragm of individual holes and of the perforation of a tray (1004, 1005); variable control by pantographic extend-retractile grid of individual holes and of the perforation of a tray (1006,1007); variable control of distance between trays and packings by moving shaft (1008, 1009); magazine for quick changeover of trays (1010) and packings (1011); flexible distribution net for variable sparging flow of micro- or nanobubbles in trays (1012), as well as in packings, reflux inlet, liquid distributors and collectors (1013); and variable height control of downcomer's weirs (1014, 1015). After distillation, the Cell (1) (100, 127) (200, 204, 207) can rapidly lower, disassemble and exchange said columns, modules, and internals for another local or relocated operation.

Partial Innovations of the Sub-Cell with Rotating Tower

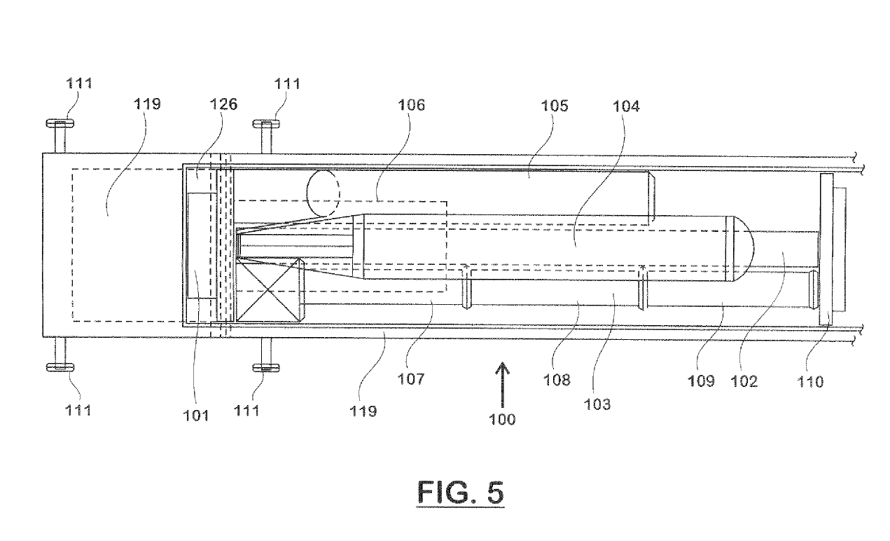

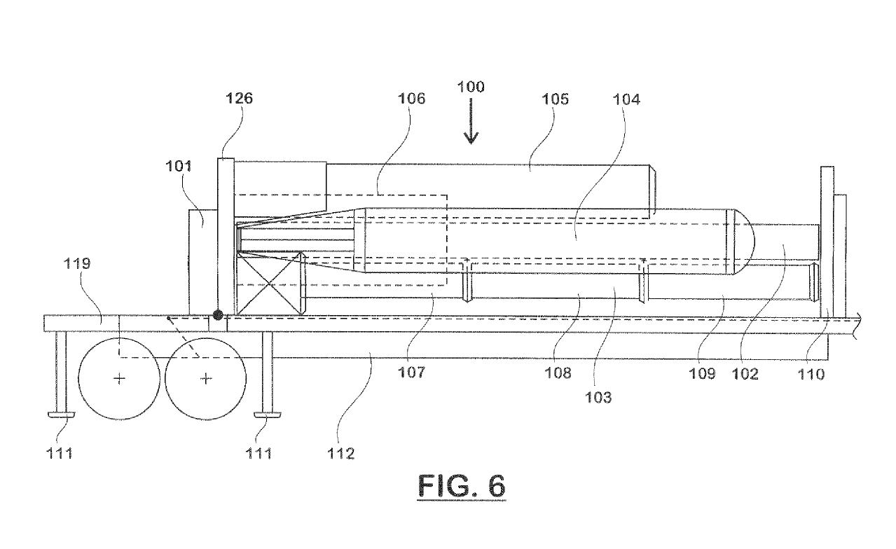

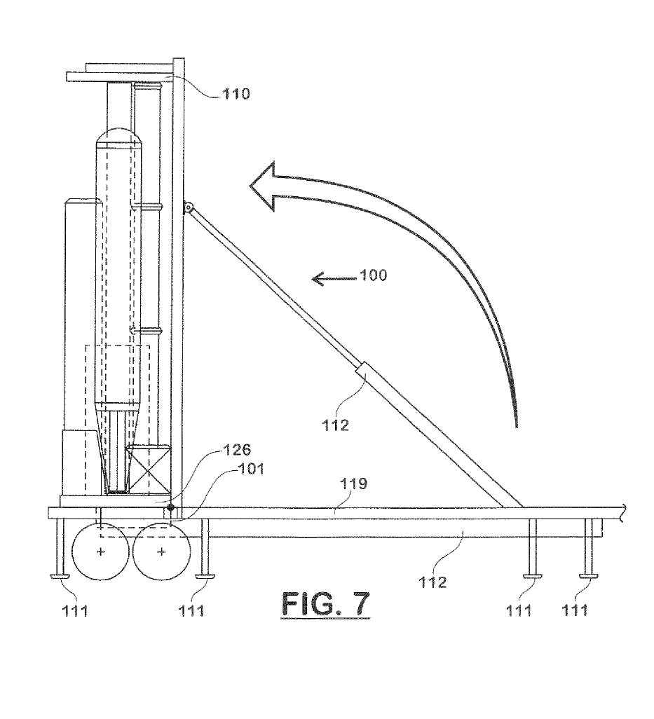

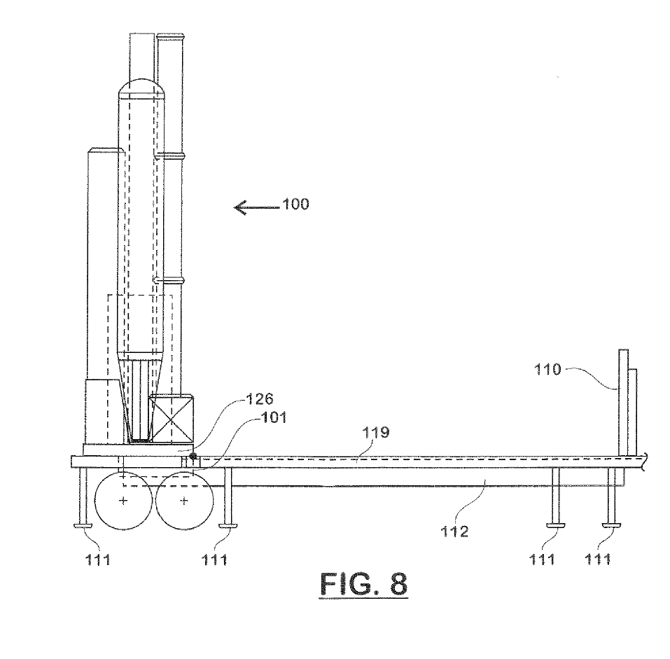

The sub-cell (100) with rotating tower (126) carries on a mobile platform (119), as exemplified in FIGS. 4 and 5, several columns (103 to 106) attached to a rotating tower(126) formed by a prism (102) with various faces made in steel or similar fixed by its lower end in the rotating center of a base (101), and fixed by its higher end in the rotating center of a retractable top (110) fastened to a hydraulic elevator (112), being the tower base (101) capable of a 90° angular movement around a hinge. The sub-Cell (100) actuates the rotating tower (126) in horizontal position for manufacturing, deployment and assembling of a variable number of columns (103 to 106) and/or column modules (107 to 109), as illustrated in FIGS. 4 and 5: with each partial turn of the tower (126), at the origin or at the destination, a column (103 to 106) or column modules (107 to 109), fulfilled with internal column components (301 to 360) of sets (1000 to 1015), can be quickly aggregated to one of the side faces of the prism (102). At the destination, before the distillation operation, as illustrated in FIG. 5 in floor plan view and in FIG. 6 in side view, the sub-cell (100) lies in horizontal position, holding attached to its base (101) and to the prism side faces (102) for example, 3 types of columns (104 to 106) forming a sequential column system covering various phases of a distillation process (11, 12, 13) and a fourth, higher column (103) formed, for example, by 3 modules (107 to 109) and prepared for operating independently of said 3 columns system (104 to 106). The prism (102) bottom end, as exemplified in FIG. 5, is fixed to the tower (126) base rotating center (101), and the prism's top end is attached to the tower (126) top rotating center (110). The hydraulic system for raising the tower (126) to the vertical position, as exemplified in FIG. 6, can encase in a housing (112) under the platform (119) whose support pads (111) can be extended and locked. By activating the hydraulic system (112), as exemplified in FIG. 7, the tower (126) is raised to the vertical position and stands on its base (101). After the tower (126) elevation, as illustrated in FIG. 8, the hydraulic activating system (112) can be retracted, and the tower's top (110), once separated from the columns (103 a 106) and prism (102), can return, with the elevator (112), to the retracted position on the platform (119). During distillation, as mentioned and will be detailed, the process can be adjusted and its parameters can be modified in real or quick time, through variable control of the vapor-liquid ratio by variations of form and position of internal components (301 to 360) of the sets (1000 to 1015), as well as, during brief interruption of the process, by changing trays and packings through above mentioned quick changeover magazines (340, 342). As mentioned and will be detailed, columns (103 to 106) and modules (107 to 109) of the sub-cell (100) can be interexchanged with other sub-cells' columns and modules, by activating said sub-cell (127) with rotating block (113), assembling guide-tracks (116), transfer guide-tracks (117) and transfer devices (118) for modules (107 a 109, 114, 205, 206, 208 a 210) and columns (103 a 106, 125, 216 a 218) between platforms (119, 120, 201). After distillation, the sub-cell (100) can rapidly lower, disassemble and exchange said columns and modules for another local or relocated operation or return to origin.

Partial Innovations of the Sub-Cell with Rotating Block

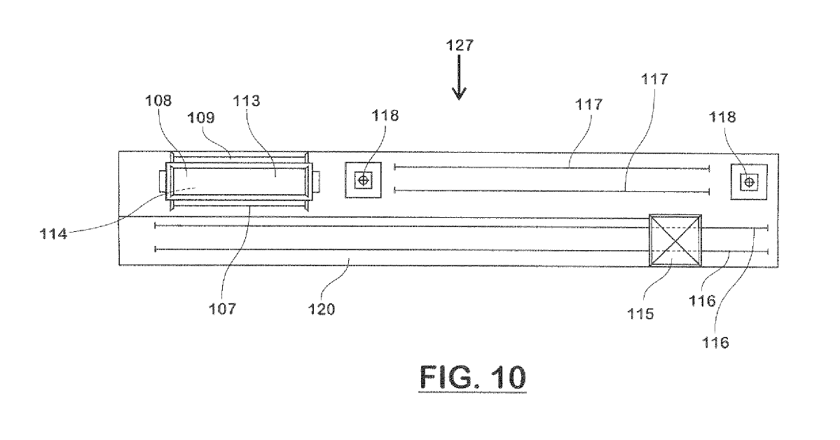

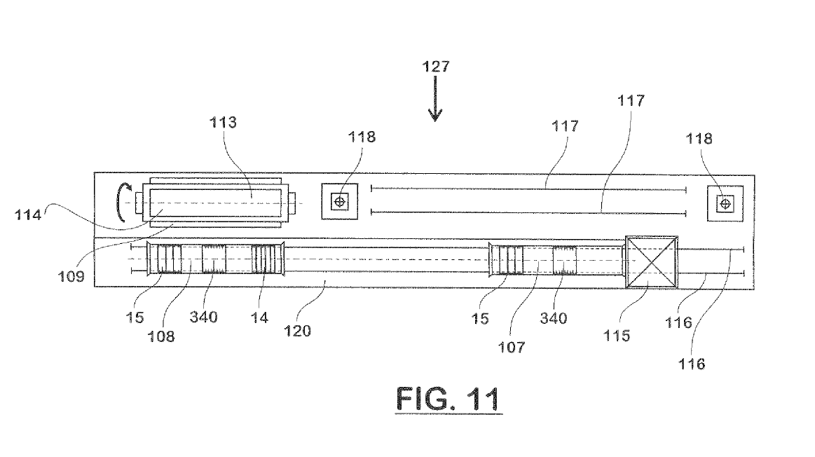

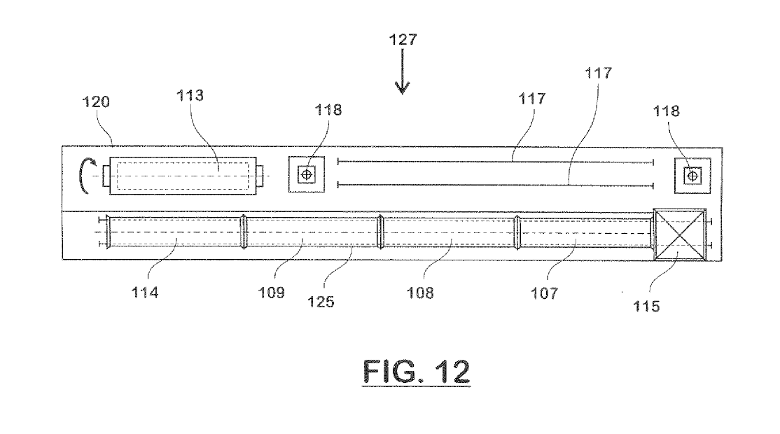

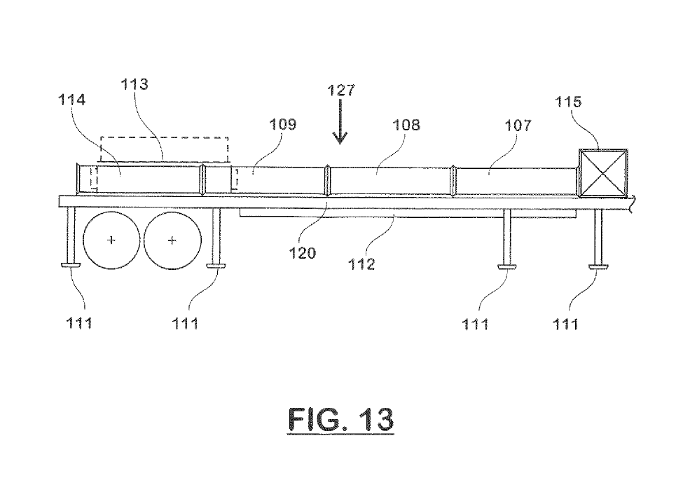

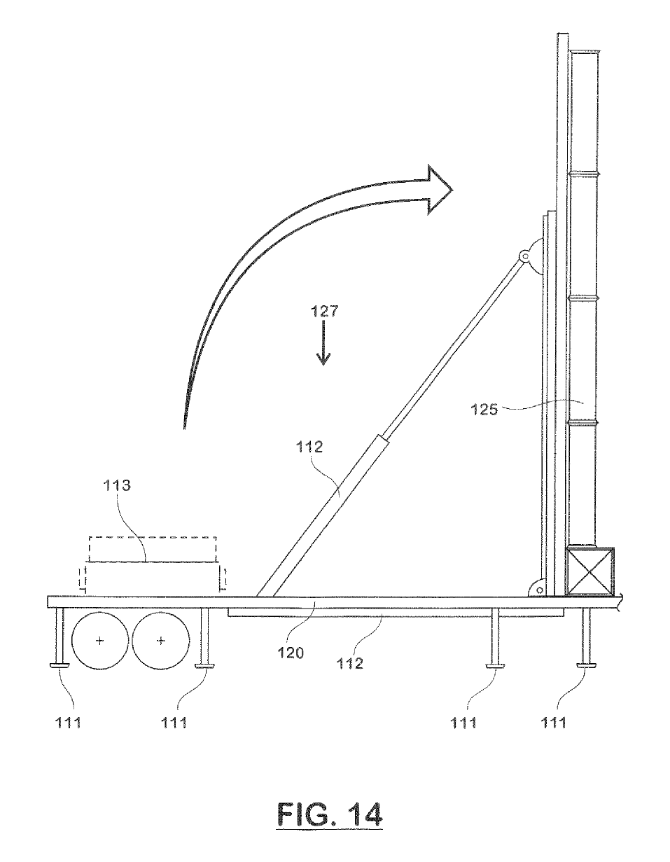

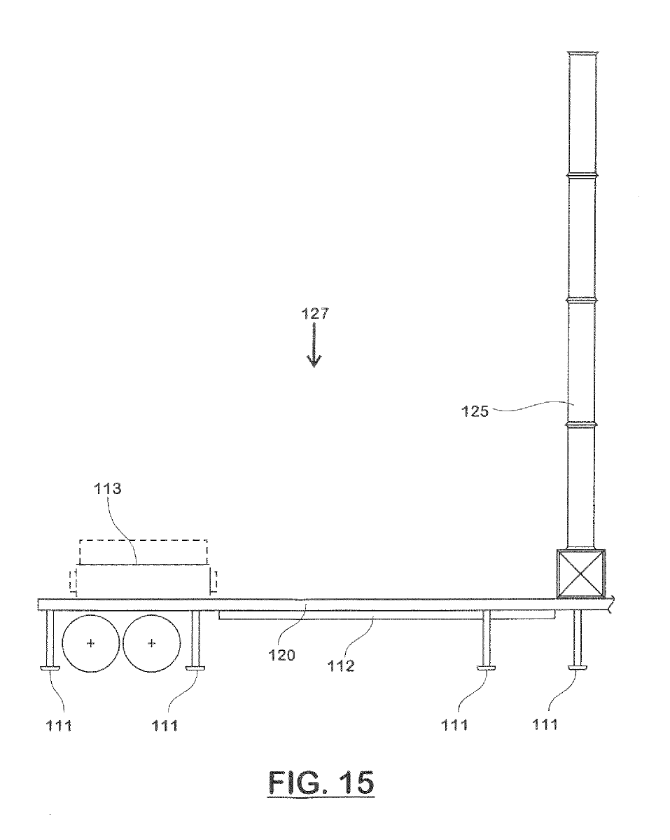

The sub-cell (127) has fixed upon a platform (120), a rotating block (113) in the form of a prism with various faces, made of steel or similar, positioned between vertical supports on a mobile platform (120), enabling, according to example in perspective in FIG. 9, at each partial turn of the block (113), the coupling to one of its faces of a module (107 to 109, 114) of a distillation column (125). The platform (120) is fitted with assembling guide-tracks (116) for alignment and fixation of the modules (107 to 109 and 114). The sub-cell (127) is fitted upon the platform (120) with a pair of transfer guide-tracks (117) and transfer devices (118) with three-dimensional movement, that can transfer modules (107 to 109, 114, 205, 206, 208 to 210) and columns (103 to 106, 125, 216 to 218), between platforms (119, 120, 201), as FIGS. 10 and 11 show. Transfer devices (118), have the form of extend-retract-tilt cranes capable of a 360° turn that can be attached at various points of the platform (120), being able to remove, handle, align and change modules and columns among sub-cells (100, 127, 200, 204, 207). FIG. 11 shows the floor plan view of the platform (120) upon which the rotating block (113) made a partial turn, placing upon the assembling guide-tracks (116) a first module (107) having the vapor generator (115) attached to its base; by another partial turn, the block (113) places upon the same assembling guide-tracks (116) a second module (108) to be attached to the first module (107). The filling of the module (107) with a packing (15) and a quick-change magazine for trays (340) and of module 108 with a packing(15), a set of trays (14) and a quick-change magazine for trays (340) is exemplified in FIG. 11; modules (109) and (114) are in the example still affixed in the rotating block (113); the transfer devices (118) and transfer guide-tracks (117) are not activated, as the example shows no module or column transfer between platforms. Before and after operation, the assembling and exchange of internal column components (301 to 360) of sets (1000 to 1015), such as trays (14, 302, 304, 305, 306, 307, 310, 315, 319, 323, 327, 331, 334, 344, 356, 359), packings (15, 330, 343, 353), distributors (17, 352), collectors (18, 354) and others, can be performed through modules' extremities (107 to 109) and by means of magazines for quick changeover of trays (340 and of packings (342). FIG. 12 illustrates the sub-cell (127), with the empty rotating block (113), after having executed four partial turns and respectively deposited said 4 modules (107 to 109 and 114) upon assembling guide-tracks (116), where they were filled with internal components of the column (125), then coupled, affixed and locked, having been attached with other connections and connected equipments, as a exemplified vapor generator (115), for the column operation. As illustrated in FIG. 12 in floor view and in FIG. 13 in side view, the assembled column (125) is still in horizontal position, being the support pads (111) of the platform (120) extended and locked and the hydraulic elevator system (112) being encased in the housing under the platform (120). The activation of the elevator (112), illustrated in FIG. 14, raises the column (125) to the vertical position of distillation process, as illustrated in FIG. 15 in side view. The process can be adjusted and its parameters can be modified, in real or quick time, through variable control of the vapor-liquid ratio by variations of form and position of internal components (301 to 360) of the sets (1000 to 1015), as well as, during brief interruption of the process, by changing trays and packings through above said quick changeover magazines (340, 342). Before and after distillation, as mentioned and will be detailed, column (125) and modules (107 to 109, 114)) of the sub-cell (127) can be interchanged with other sub-cells'(100, 200, 204, 207) modular columns and modules, by activating said sub-cell's (127) assembling guide-tracks (116), transfer guide-tracks (117) and transfer devices (118) for modules (107 a 109, 114, 205, 206, 208 a 210) and columns (103 a 106, 125, 216 a 218) between platforms (119, 120, 201). After distillation, the sub-cell (127) can rapidly lower, disassemble and exchange said columns, modules, and internals for another local or relocated operation or return to deposit.

Partial Innovations of the Sub-Cell with Articulated Modules

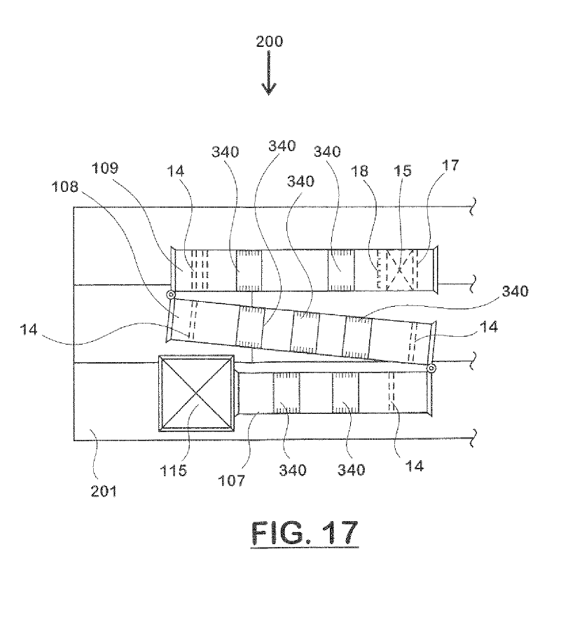

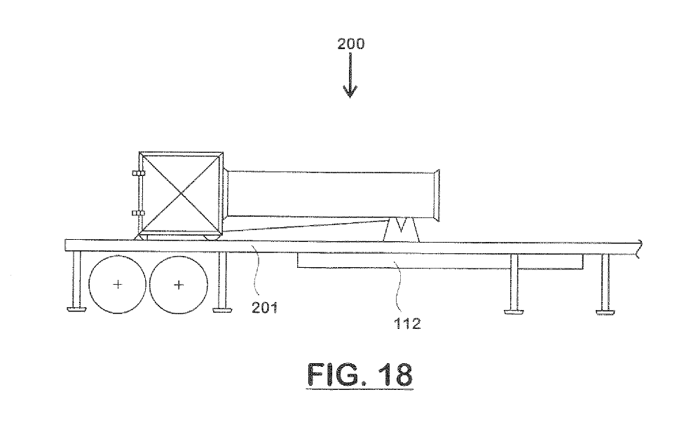

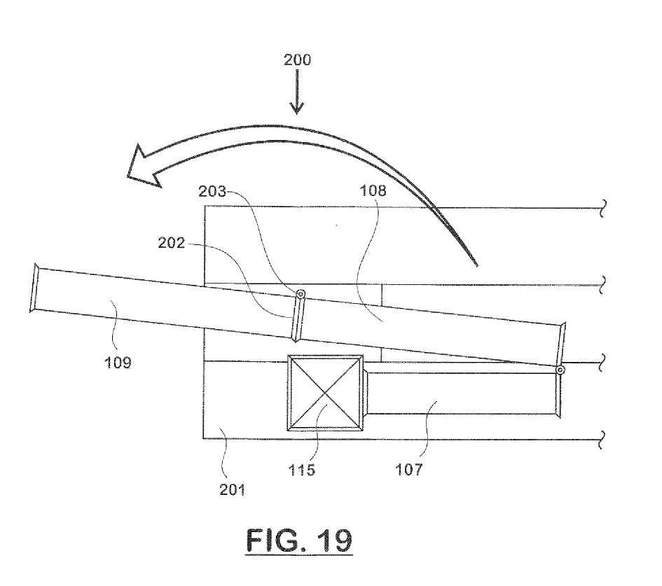

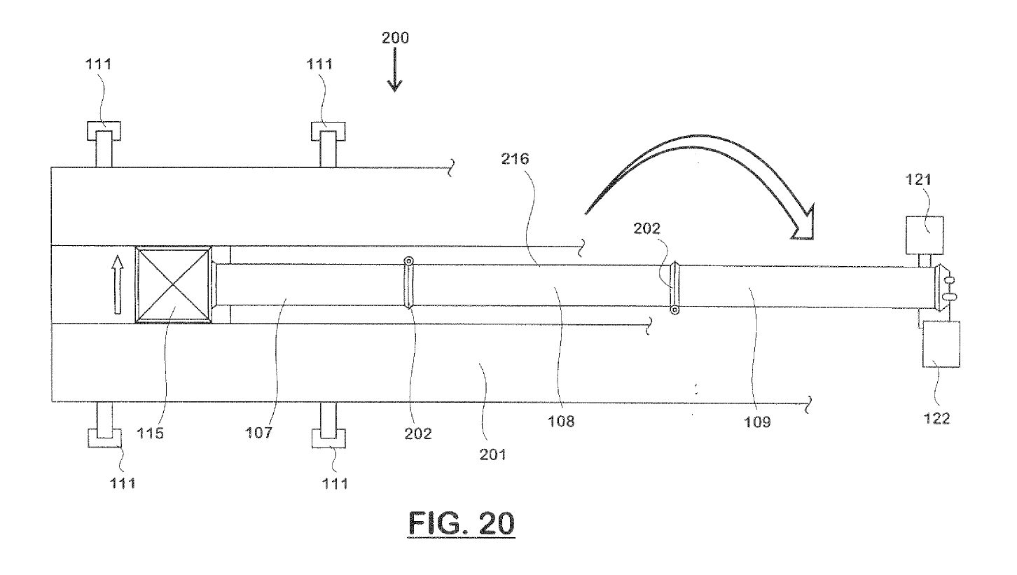

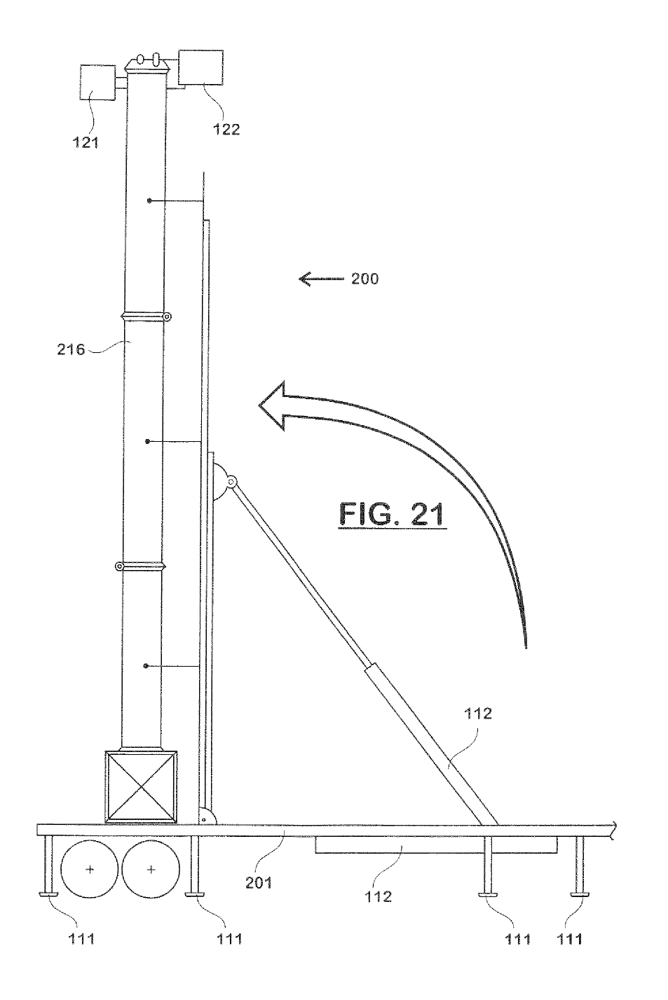

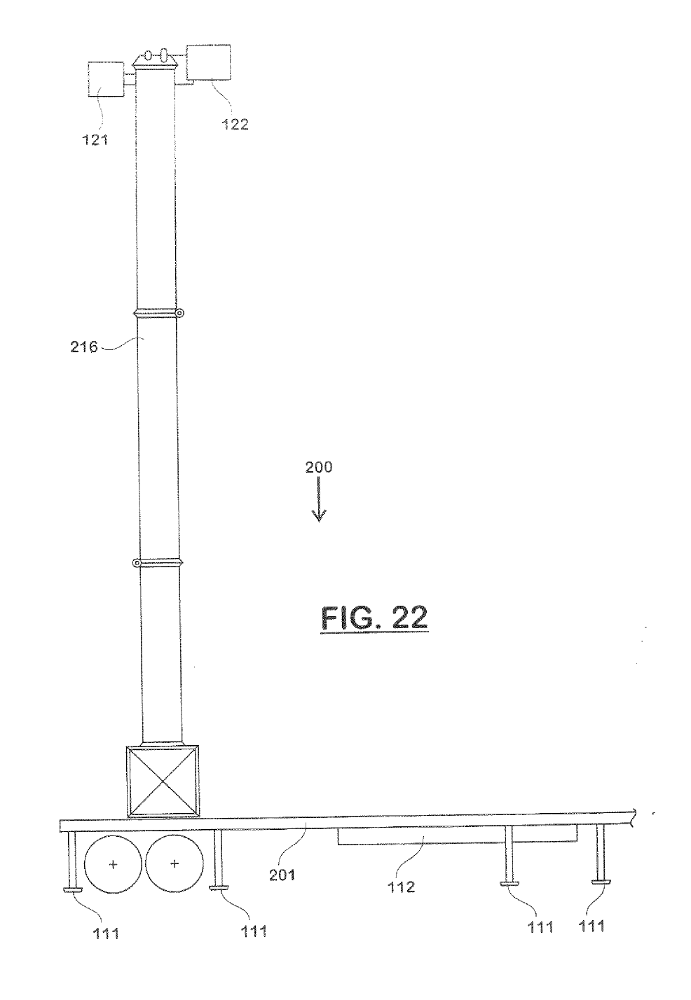

The sub-cell (200) comprises a column (216), whose height may exceed the measure of a mobile platform (201) (example on FIG. 16), and is formed with articulated, foldable modules (107 to (109), which can vary in number and form, and have in their extremities articulation hinges (203) and junction flanges (202); modules (107 a 109) are in said figure showed in horizontal position over the mobile platform (201), being the module (107) fixed on the column's base (216) that may contain a reboiler (115). The setting, assembly and articulation of the modules (107 a 109) of the column (216) in the origin, as well as their eventual exchange with other modules at the destination, may be performed by actuating the rotating block 113) of the sub-cell (127) fitted with transfer guide-tracks (117) and transfer devices (118) for transfer and exchanging modules (107 to 109, 114, 205, 206, 208 a 210) and columns (103 to 106, 125, 216 a 218) between platforms (119, 120, 201), as shown in FIGS. 10 to 12. As FIG. 17 exemplifies in floor view the modules (107 to 109) start their unfold in horizontal position, on which they can be filled with internal components like trays (14, 302, 304, 305, 306, 307, 310, 315, 319, 323, 327, 331, 334, 344, 356, 359), packings (15, 330, 343, 353), distributors (17, 352), collectors (18, 354) and other (301 a 360) of the sets (1000 to 1015), through a module's extremity and in its central part by magazines for quick changeover of trays (340) and of packings (342). The sub-cell (200) is shown in side view in the example of FIG. 18, with the housing of the hydraulic system of elevation (112) retracted under the platform (201). The unfolding, fixation and locking of two modules (108, 109) by means of flanges (202), all modules (107 to 109) remaining in the horizontal on the platform (201), is exemplified in FIG. 19 in plant view. The complete unfold with fixation and locking by the flange (202) of the 3 modules (107 to 109), remaining the column (216) still in horizontal position over the platform (201), is illustrated in the example of FIG. 20 in plant view; in this position, as in the same figure, other connected equipments can be assembled on the top of the column (216), for example, a condenser (121) and a cooler (122); in said example, the module (107) at the column base mounted on a vapor generator (115) has been moved from the side to the center of the platform (201), for example by using said transfer systems of sub-cell (127), being the support pads (111) of the platform (201), activated and locked. After completed modules articulation and fixing, the column (216) can be elevated to the vertical position, as exemplified in FIG. 21, by activation the hydraulic system (112) of the sub-cell (200). FIG. 22 illustrates in side view the final positioning of the column (216) for distillation, being the hydraulic elevator system (112) retracted in the housing. During distillation, as mentioned and will be detailed, the process can be adjusted and its parameters can be modified, in real or quick time, through variable control of the vapor-liquid ratio in internal flexible components (301 to 360) of the sets (1000 to 1015), as well as, during brief interruption of the process, by changing trays and packings through above said quick changeover magazines (340, 342). Before and after distillation, as mentioned and will be detailed, column (216) and modules (107 to 109) of the sub-cell (200) can be interchanged with other sub-cells'(100, 127, 204, 207) modular columns and modules, by activating said sub-cell's (127) assembling guide-tracks (116), transfer guide-tracks (117) and transfer devices (118) for modules (107 a 109, 114, 205, 206, 208 a 210) and columns (103 a 106, 125, 216 a 218) between platforms (119, 120, 201). After distillation, the sub-cell (200) can rapidly lower, disassemble and exchange said columns, modules, and internals for another local or relocated operation or return to origin.

Partial Innovations of Sub-Cell with Articulated Modules, Being at Least One Telescopic

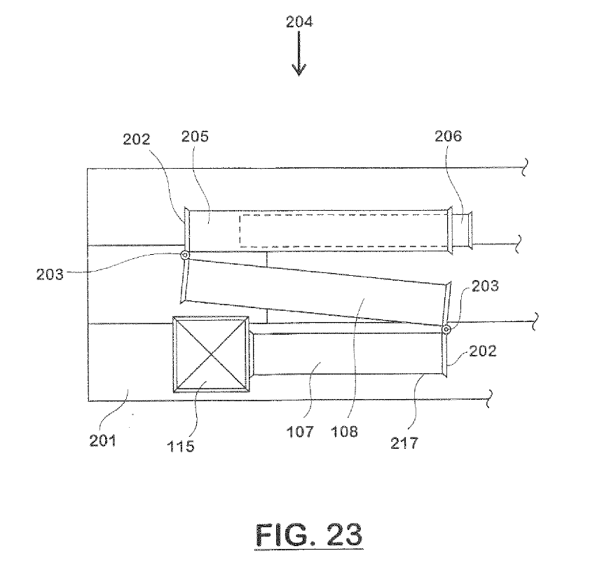

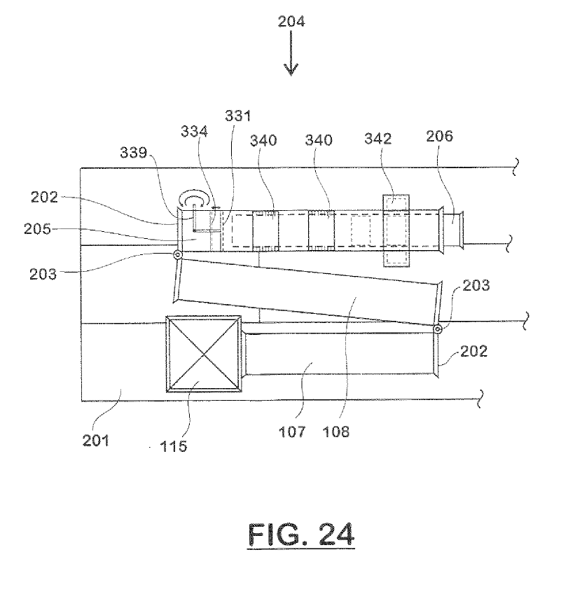

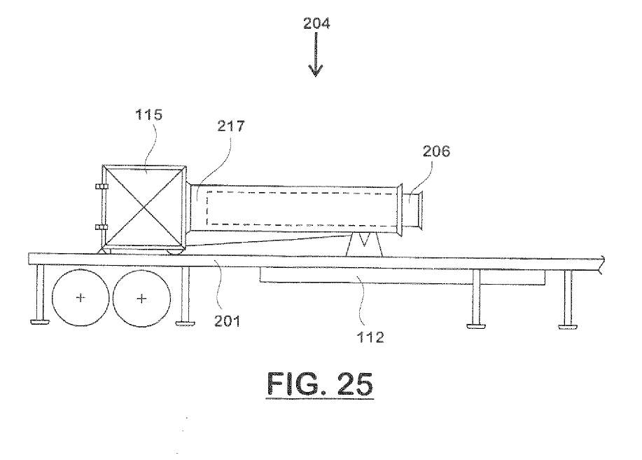

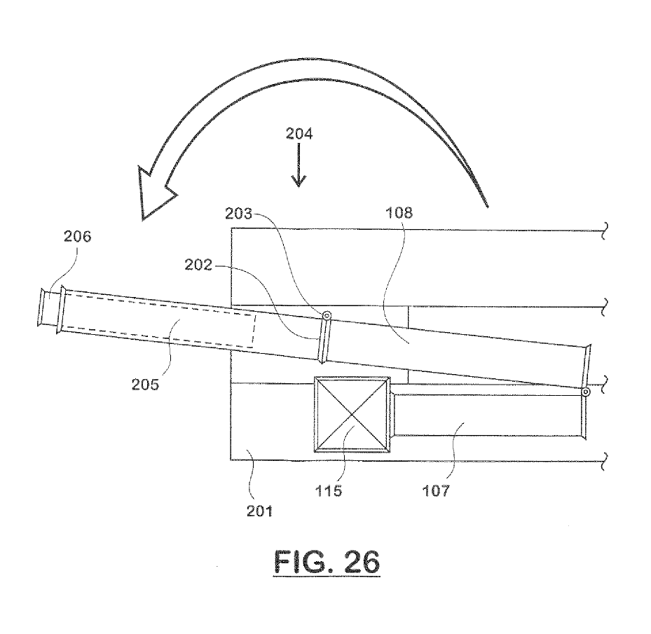

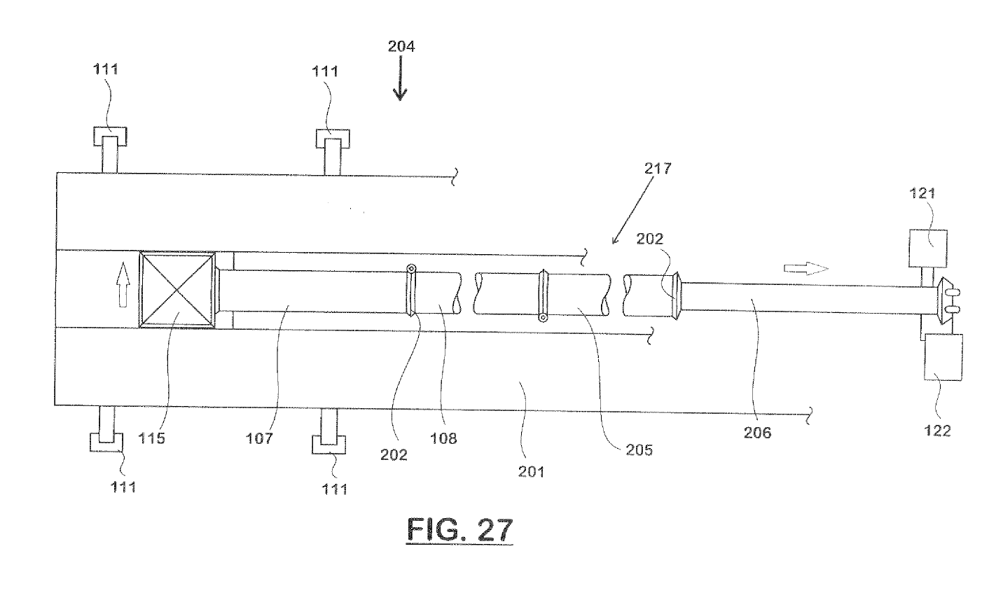

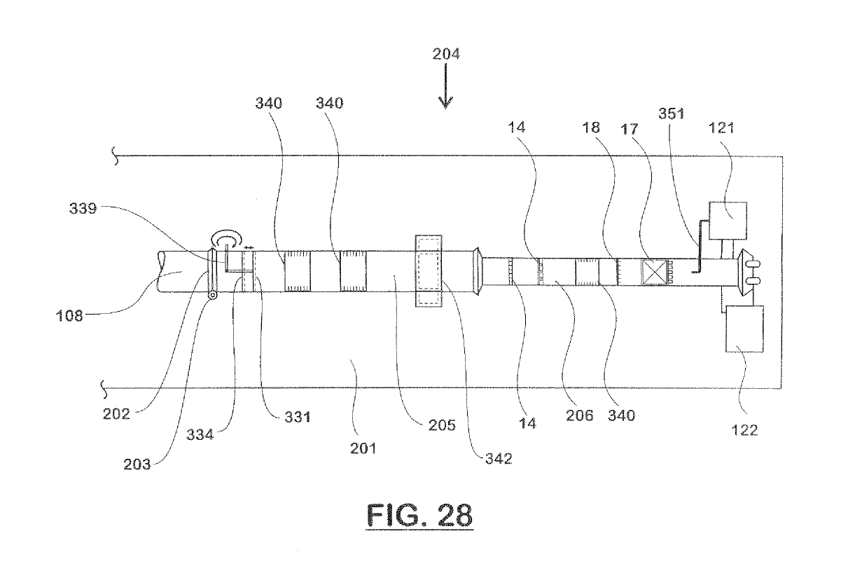

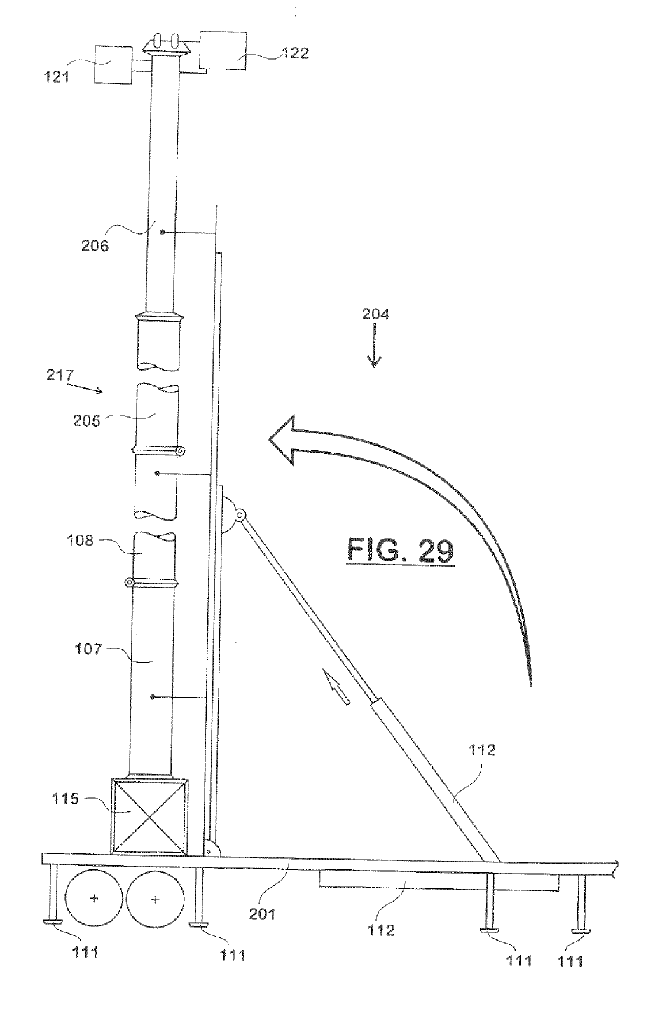

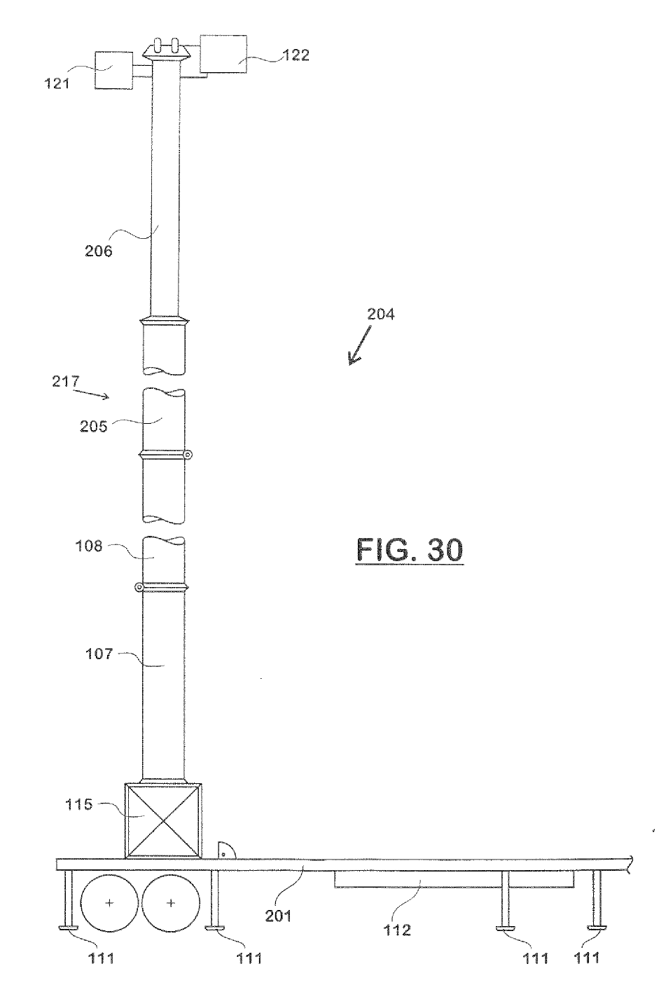

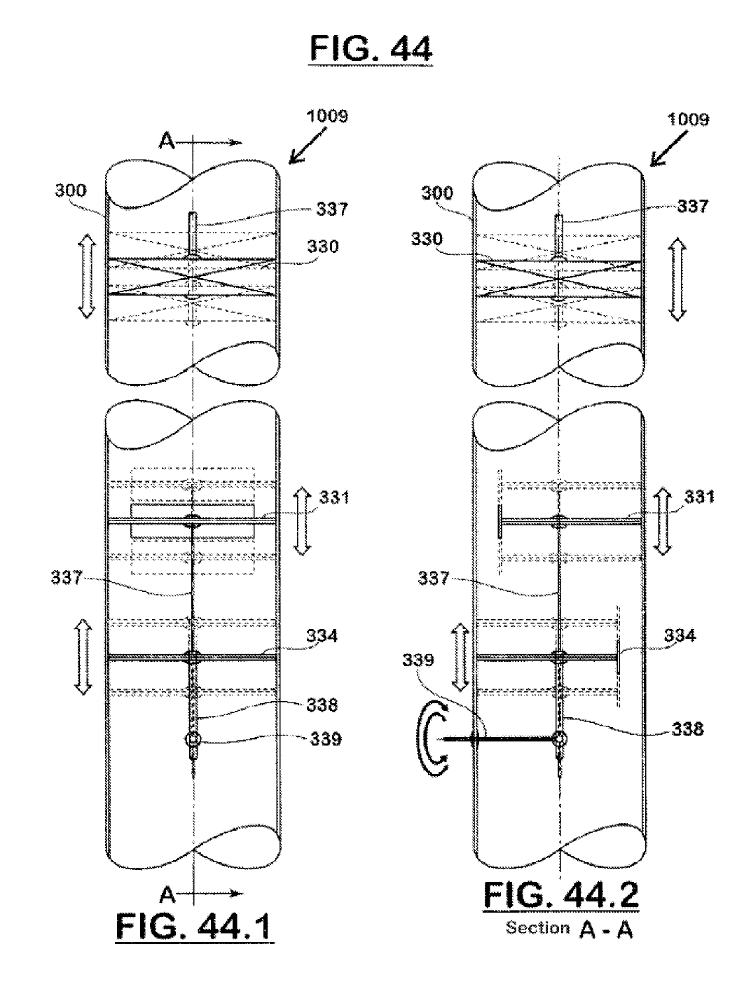

The sub-cell (204) comprises on a mobile platform (201) a column (217), for example, with 4 modules (107, 108, 205, 206), in other all features similar to sub-cell (200) except that a module (206) has a extend-retract telescopic movement, as exemplified in FIG. 23. As FIG. 24 exemplifies, by unfolding modules in horizontal position on said platform, being the telescopic internal module (206) retracted, the telescopic external module (205) can be fulfilled with column internals (301 to 360) of the sets (from 1000 to 1015), as in the example, two quick changeover magazines (340) for trays, one quick-changeover magazine (342) for packings, and a retracted device of distance variation of internal components (339, see example in FIG. 44) with two trays (331, 334). The elevator system (112) exemplified in FIG. 25 in side view, and the unfolding and joining of modules around hinges (203), and flange (202) locking as illustrate FIGS. 26 and 27 in floor view are similar to sub-cell (200). FIG. 28 shows examples of details of the filled internals in the now aligned and by flanges (202) fixed modules (205) and (206) of column (217), which still remains in horizontal position: module 205 is fulfilled as exemplified in FIG. 24; module (206) is fitted from the top on with a cooler (122), a condenser (121) and respective reflux inlet (351), a liquid distributor (17), a liquid collector (18) a quick-changeover magazine (340) for trays, and two trays (14). The activation of the elevator (112) raising the column (217) to the vertical, being the platform (201) pads (111) extended and locked is exemplified in FIG. 29. The subsequent retraction and housing of the elevator (112) and the setting free of the column (217) for distillation, is exemplified in FIG. 30. Vapor-liquid ratio variable control during distillation for process adjustment and modifications, and, after distillation, the lowering of the column (217) and the changing of modules and column internals are similar to the described in sub-cell (200), except the reversal, retracting telescopic movement of module (206).

Partial Innovations of Sub-Cell with Articulated Modules surrounded by Metal Structure

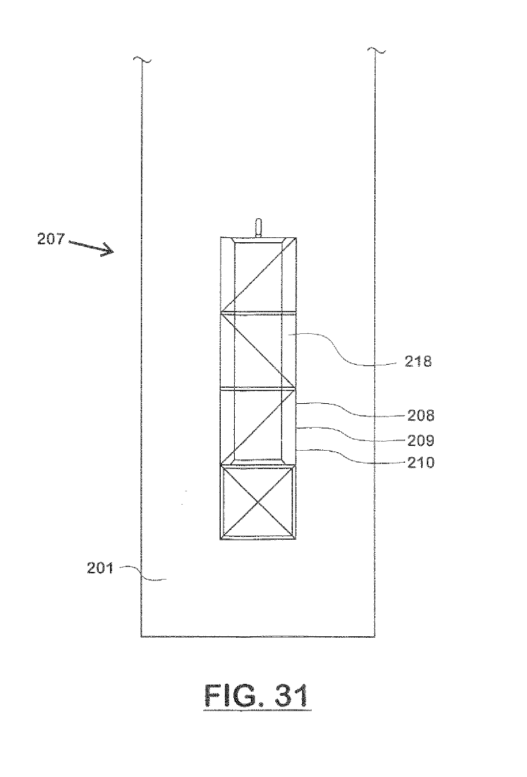

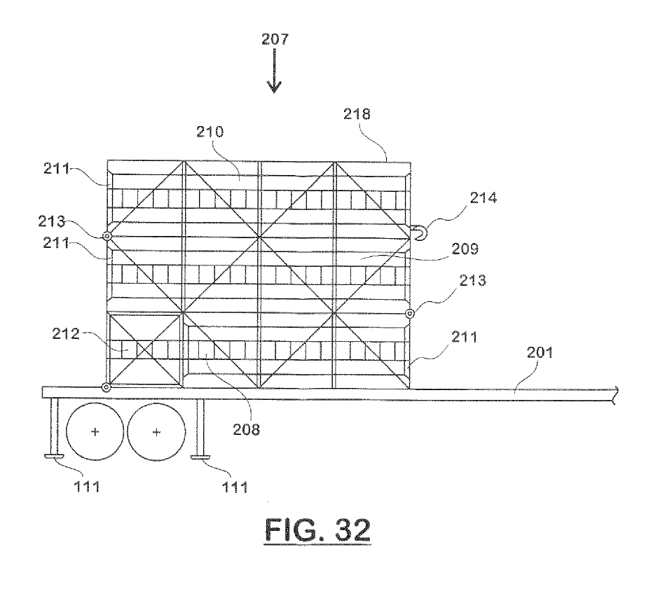

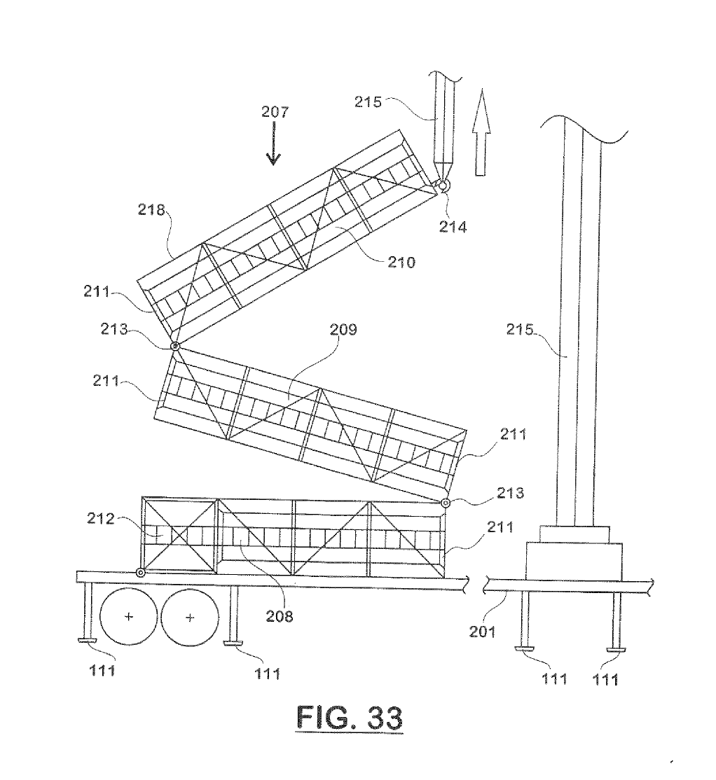

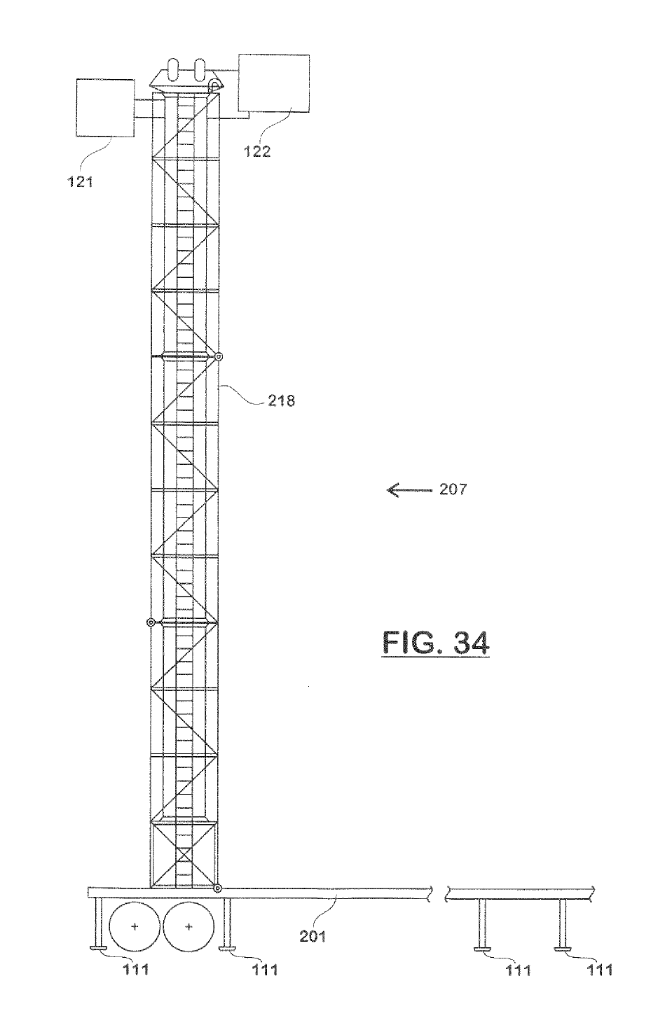

The sub-cell (207) comprises a column (218) composed for example, of various articulated modules (208 to 210), that are surrounded by a metal structure, as exemplified in FIG. 31, in plant view. As illustrated in FIG. 32 illustrates in side view the 3 superposed modules (208 to 210) encased by metal structures, articulates by hinges (213) in flanges (211), being the upper module (210) fitted with a lifting hook (214), and standing the lower module (208) over a vapor generator (212), encased in said metal structure. The agile lifting of the modules (208 to 210) by means of a lifting device (215) raises the column (218) to the vertical position, as illustrated in FIG. 33 in side view, being extended and locked the supporting pads (111) of platform (201) and of a lift (215) fixed over the platform (201). The column's elevation (218) to the vertical position of operation, having attached to its top, for example, a condenser (121) and a cooler (122), is illustrated in FIG. 34 in side view. Sub-cell (207) can exchange modules before and after the distillation, similarly to sub-cells (200, 204), except that in sub-cell (207) a prior disconnection of hinges (213) is required. The use of quick-changeover magazines (340, 342) for exchanging trays and packings during brief interruption of distillation process, as per sub-cells (200, 204), requires in sub-cell (207), for example, a framed “window” opening at the metal structure in front of a sliding hatch (341) in a column (300). Vapor-liquid ratio variable control by flexible internals in sub-cell (207) are similar to the described in the other sub-cells (100, 127, 200, 204).

Partial Innovations of Variable Control of the Liquid-Vapor Ratio Through Variable Geometry in Internal Column Components

The cumulative increase of flexibility and efficiency of the distillation process by variable control and optimization of the vapor-liquid ratio in the internal components of the column systems of said flexible, mobile sub-cells (100, 127, 200, 204, 207) that functionally integrate the Cell (1) is obtained by following partial innovations:

By device (1000) for variable control of a “butterfly”-type tray inclination in real process time: as FIG. 35 exemplifies, a perforated tray (302) is attached to a horizontal gyratory axis (301), the tray only touching the wall of a downcomer (16), so that the tray (302), by electromechanical activation of the axis (301)—which can be computerized and automated—can rotate, for example, up to 90°, starting from the horizontal position of the tray in perpendicular plane to the column, until the tray is in a vertical position, parallel to the vertical line of the column's wall, thus inhibiting the perforate trays function or disabling it during the process. The axis rotation (301) may, alternatively, give only slight and gradual inclinations to the tray (302) for minor adjustments of vapor-liquid ratio.

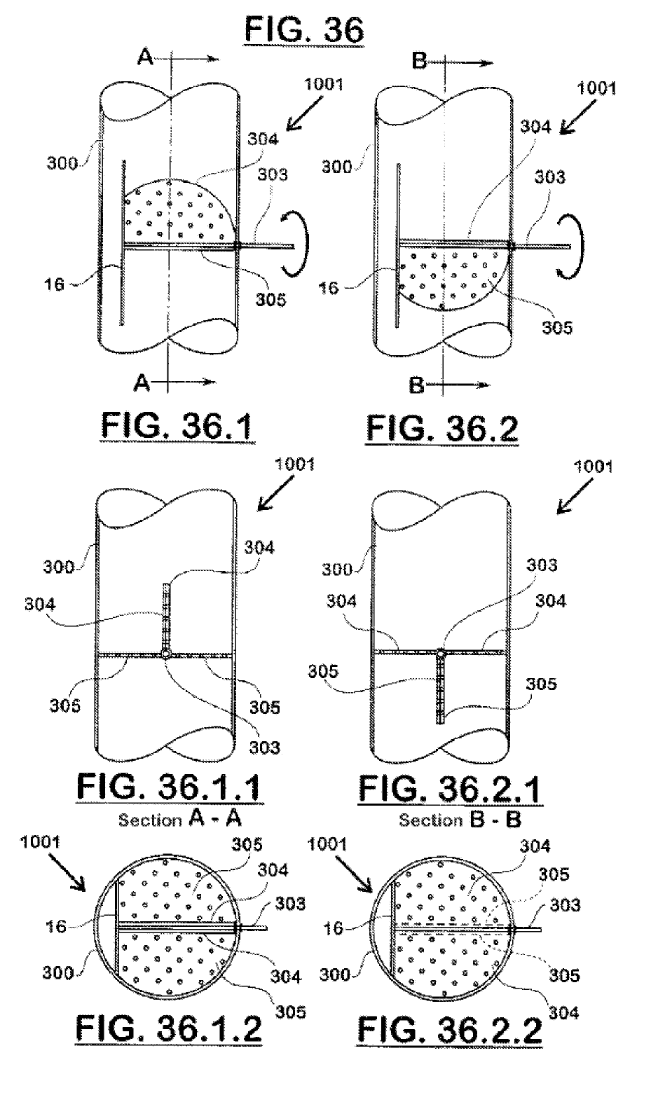

By device (1001) for variable control of the geometry of “double-folding butterfly”-type trays in real-time process: FIG. 36 shows two superposed perforated trays (304, 305), only touching the wall of a downcomer (16), being the perforation of the upper tray (304) different from the perforation of the lower tray (305). Each trays (304) and (305) is divided in two halves, so that the two halves of the upper tray (304) may fold up around gyratory, concentric, independent axes (303), gradually up to the vertical position, perpendicular to the plane of the lower tray (305). In this position, the top tray's function (304) is inhibited or disabled, allowing this stage of the process to occur entirely in the lower tray (305). Alternatively, the lower tray (305) can fold downwards in part or completely, allowing free operation of the upper tray (304), which remains in a horizontal position. Both trays (304) and (305) can also operate together, combining their two holes, both in a horizontal position. It's also possible to fold the two trays—the upper (304) folding upwards and the bottom tray (305) downwards—so that this section of the distillation column is practically disabled. The axes can have electromechanical control which can be computerized and automated.

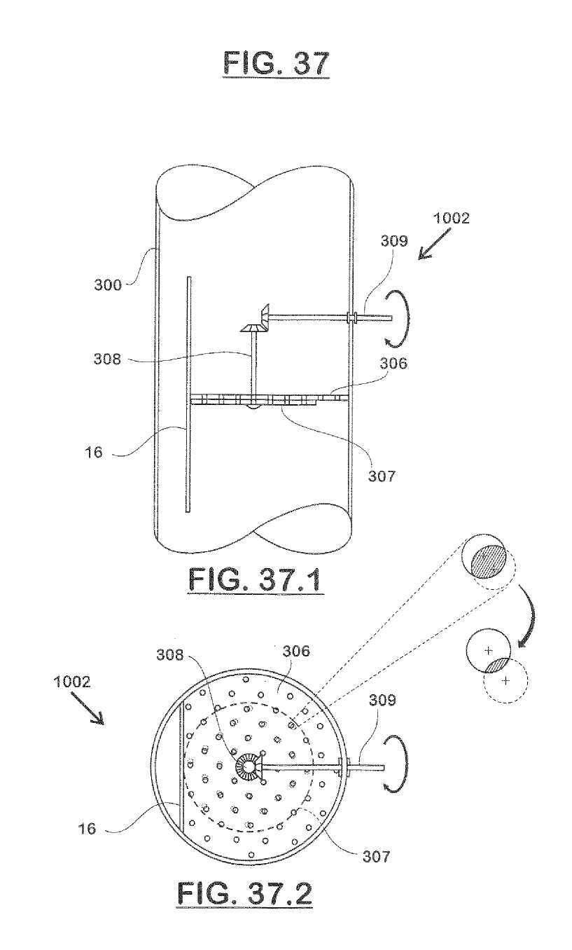

By device (1002) for variable control of the opening of the tray holes by perforated concentric trays with adjustable spin: FIG. 37 shows a fixed perforated tray (306) superposed to another mobile perforated tray (307) fastened to a vertical swivel axis (308), which is activated by a horizontal swivel axis (309), being trays (306, 307) concentric, so that the axis (309) by electromechanical activation, that can be computerized and/or automated, can transmitt rotation to the tray (307). In the initial position, the perforations of trays (306) and (307) coincide, but as the lower mobile tray (307) gradually rotates, its holes can open or close the holes of the fixed tray (306), thus varying and adjusting in real process time the vapor-liquid ratio in the fixed tray (306).

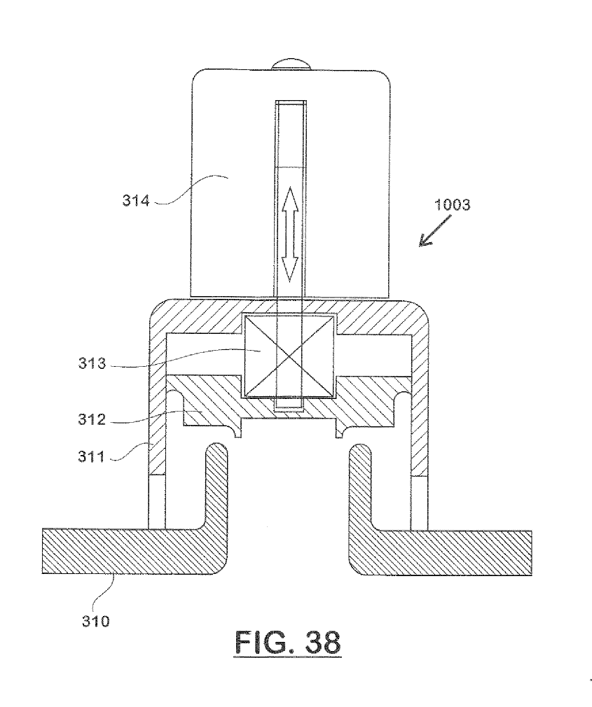

By device (1003), for variable control of an adjustable bubble-cap sealing, by solenoid or other control system. FIG. 38 shows the cross view of a perforated tray (310) with a fixed bubble-cap (311), or valve, whose mobile sealing (312) is controlled by a spring shaft (313) activated, in the example, by a solenoid (314), thus controlling vapor flow pressure in the tray's hole. This device, which can be coupled to an electronic control system with programming and/or automation, can provide fine tuning of the vapor-liquid ratio in real process time.

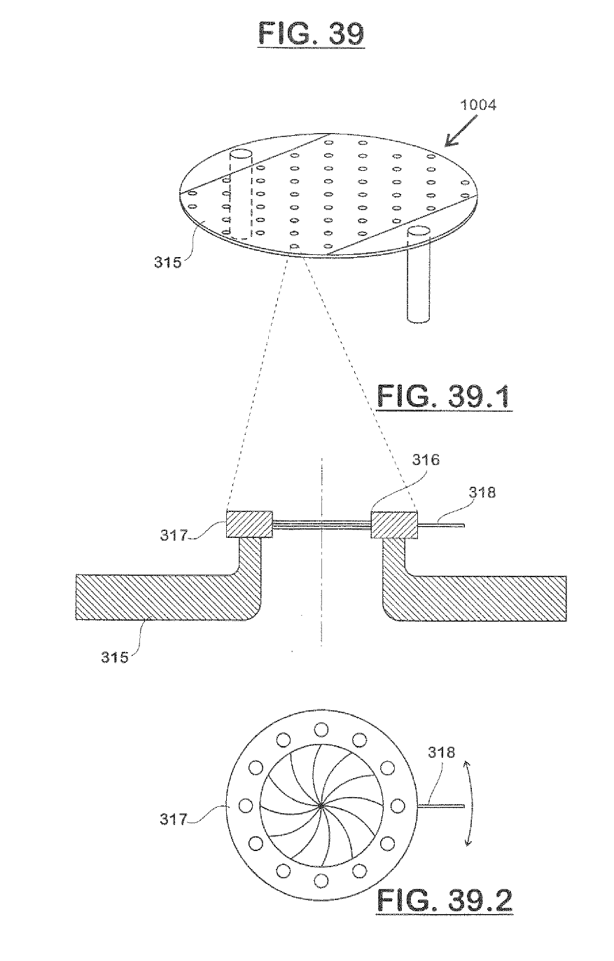

By device (1004) for variable control of the vapor-liquid ratio by “iris diaphragm” (317) in an adjustable opening of a tray's hole, and of an individual bubble-cap, with a solenoid or other control system: FIG. 39 shows a variable control device, by “iris diaphragm” (317), of the hole opening (316) of a perforated distillation tray (315)—it can be also a bubble-cap hole or vapor riser. The diaphragm (317) is gradually opened or closed by solenoid activation (318) or other system, that can be computerized and automated, thus enabling a fine tuning of the vapor-liquid ratio in each hole (316) or fixed bubble-cap or valve, that is, in distributed points of the tray, in real process time.

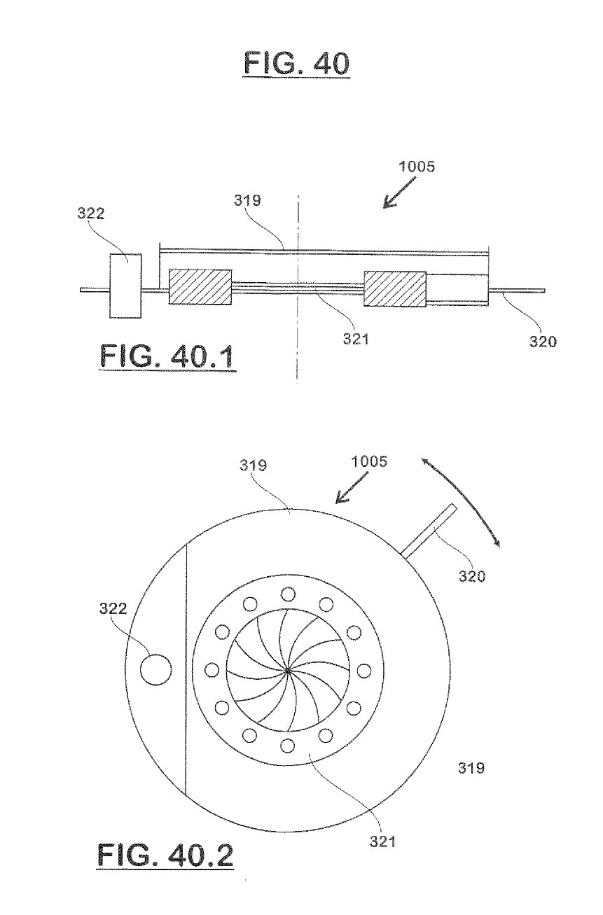

By device (1005) for variable control of a tray's perforation by “iris diaphragm” (321) activated by solenoid or other control system: FIG. 40 illustrates the control, by “iris diaphragm” (321), of a set of holes of a perforated tray (319). The diaphragm (321), located on the lower face of the tray (319), is gradually opened or closed, with activation (320) by solenoid or other control system, enabling fine tuning of the vapor-liquid ratio in the tray in real process time. The device can have computerized and automated control.

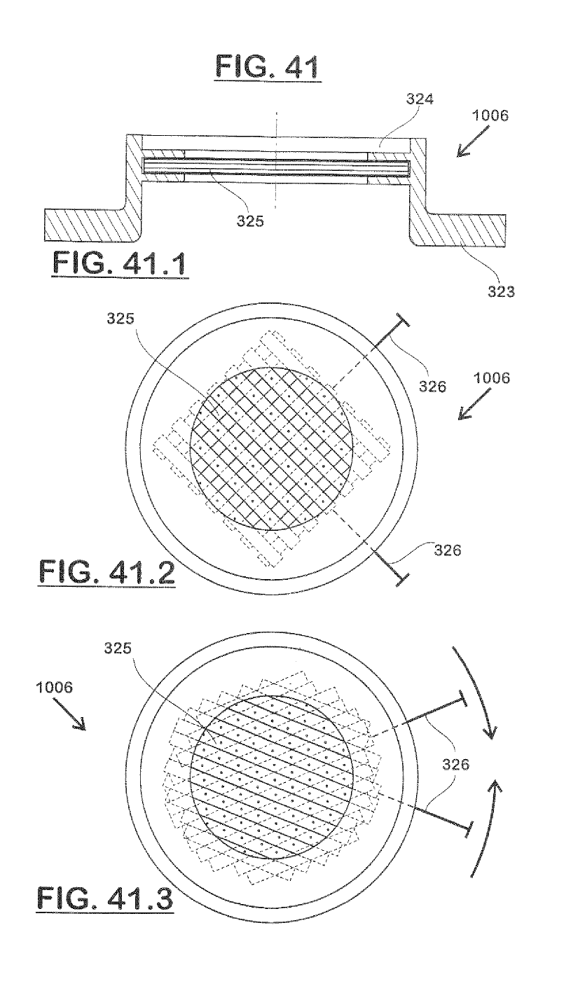

By device (1006) for variable control of the opening of the individual tray holes or fixed bubble-cap holes by pantographic grid regulated by solenoid or other control system: FIG. 41 exemplifies a circular grid (325) composed of crisscrossed metal bars (or other compatible material), which can open and close by pantographic movement with activation (326) by solenoid or other motion control system, which can be computerized or automatic. The pantographic grid (325), applied to each hole (324) of a perforated tray (323), allows, in real time, by controlling the opening of the individual hole, the distributed vapor-liquid ratio control in the tray.

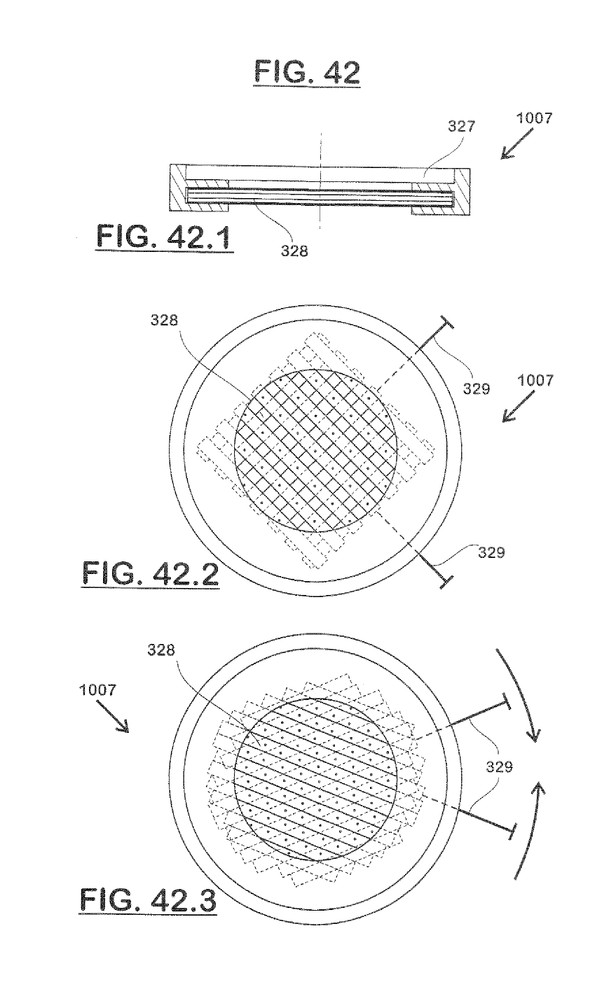

By device (1007) of variable control of a tray perforation through pantographic grid (328: FIG. 42 illustrates a circular grid (328) composed of crisscrossed metal bars (or other compatible material), which open and close by pantographic movement with activation (329) by solenoid or other motion control system, which can be computerized and automated. The pantographic grid (328), applied at the underside of a perforated tray (327), enables real-time control of the opening of the tray's perforation and thereby of the vapor-liquid ratio in the tray.

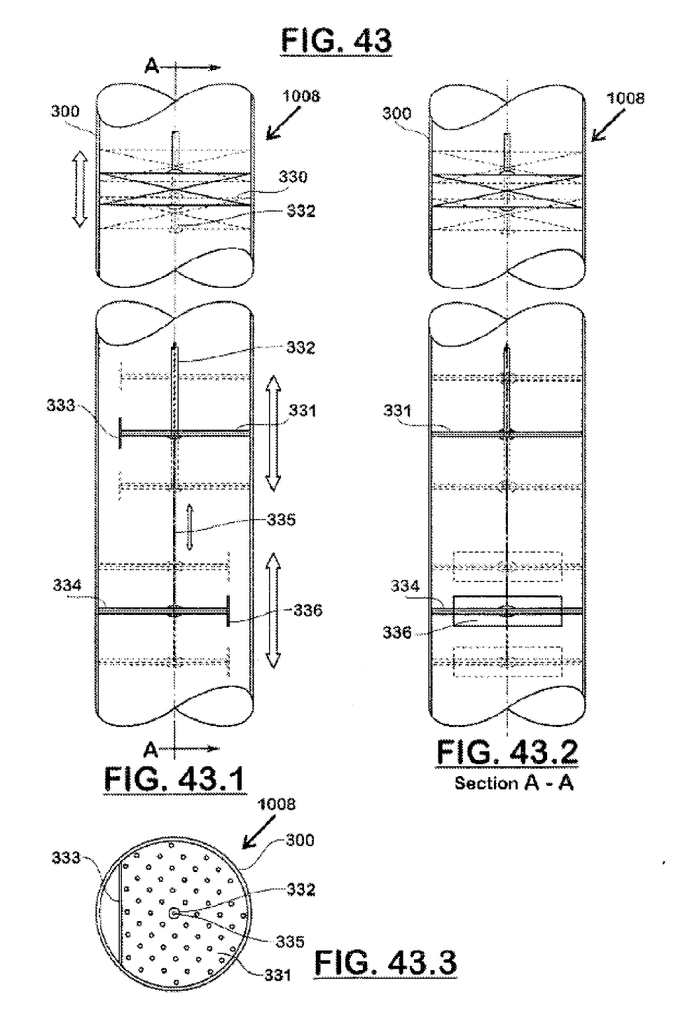

By device (1008) for variable control of the vertical distance between trays (331, 334) and/or packings (330) in a distillation column (300) in real-time process: FIG. 43 shows a column body (300), inside of which there are concentric vertical rods (332) and (335), on which trays (331, 334) are affixed, and/or packings (330), the rods being fitted with vertical movement, by electromechanical activation, which can be computerized and automated, changing the distance between trays (331, 334) and/or packings. (330).

FIG. 44 detailing FIG. 43 exemplifies a device (1009) in which the rods for varying the distance between trays and/or packings have vertical movement through a horizontal set of swiveling axes (339) with movement transfer and electromechanical activation which can be computerized and automated.

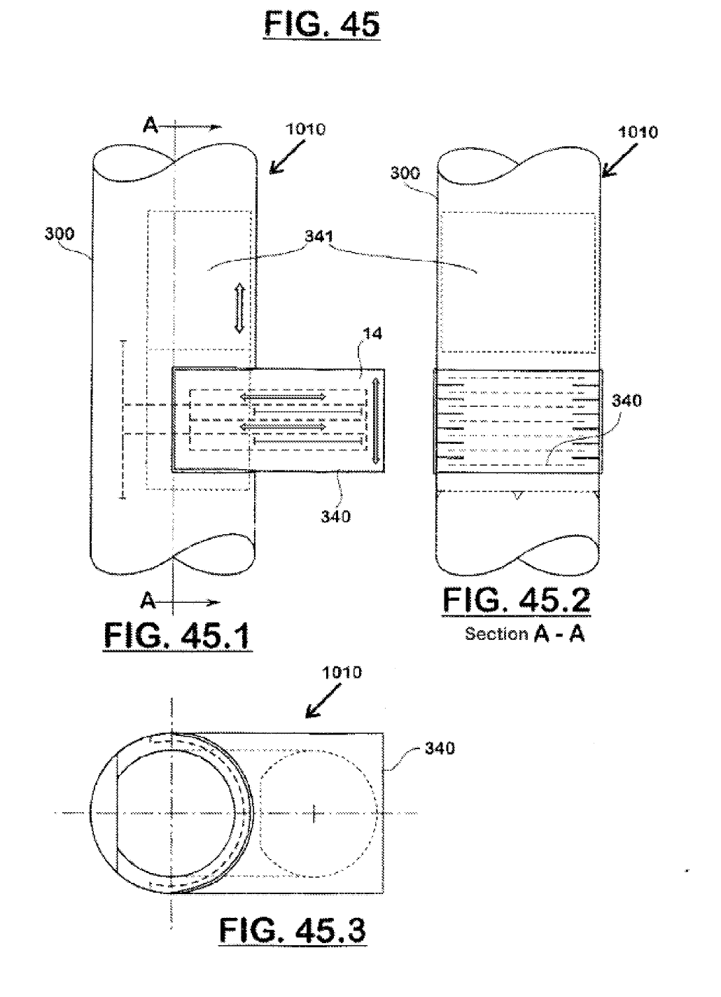

By magazine device (1010) coupled to the side of a column (300) for agile and flexible exchange of trays (14) during brief intermittence in the distillation process: FIG. 45 shows a magazine (340), made is steel or similar, attached to the side of the column (300) and capable of moving trays (14) through a sliding hatch (341) of the column. The magazine comprises a box with tray chambers inside a container, in said figure an example of 4 chambers, being alternatively some, in the example 2 chambers void, destined each to withdraw one tray from a column, and some, in the example 2 chambers filled each with one tray to be inserted in the column; by means of extend-retractile arms with tags, fitting each chamber, one tray can be extracted from the column and housed in a void chamber, and one tray can be inserted and fixed by quick-fix slots in the desired position in the column; the chamber box being fitted with vertical movement, by hydraulic, pneumatic or another conventional controllable gradual motion mechanism, inside the magazine's container, for better aligning a chamber with the desired tray position inside of the column; this quick-changeover process doesn't involve manual operation of assembly/disassembly and can be activated by remote, computerized or automated control. For manual quick operations, as in combination with device (1012), the inferior face of the magazine container (340) can be fitted with a sliding hatch permitting access to the trays chambers.

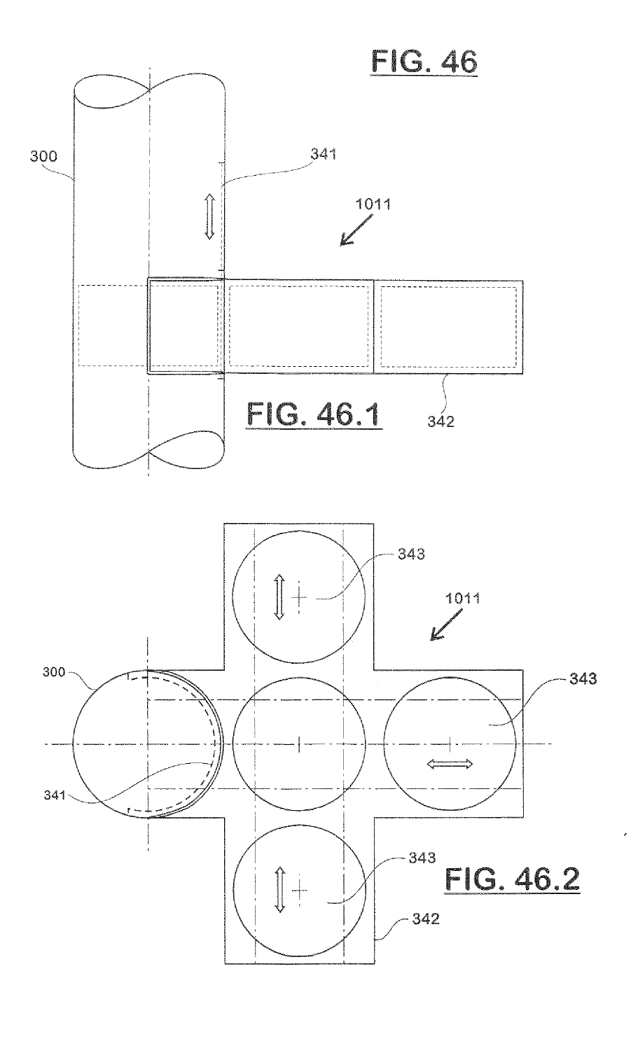

By magazine device (1011) comprising contiguous chambers (342), coupled to the side of the column (300) for flexible and rapid exchange of packings (343) during brief intermittence of the distillation process: FIG. 46 shows a magazine (342) in the form of contiguous chambers (for example, in the shape of a cross), coupled to the side of the column (300), containing each chamber one packing, in this example 3 of them, around a central void chamber fitted with extend-retractile arms with tags and capable of turning in order to reach each other chamber, to extract or insert a packing, so that through an opened sliding hatch (341) at the column (300) side, a packing can be inserted and fixed by quick-plugging slots in an adequate position inside the column, or vice-versa a packing can be extracted from the column and inserted in a magazine chamber, so that another packing can be inserted into the column, in a quick changeover process without involving manual disassembly/assembly operations. The sliding of column hatches at the quick changeover of packings can be activated by remote, computer or automated electromechanical control. For manual quick operations, as in combination with device (1013), the under face of the magazine container (342) can be fitted with a sliding hatches permitting access to packings chambers.

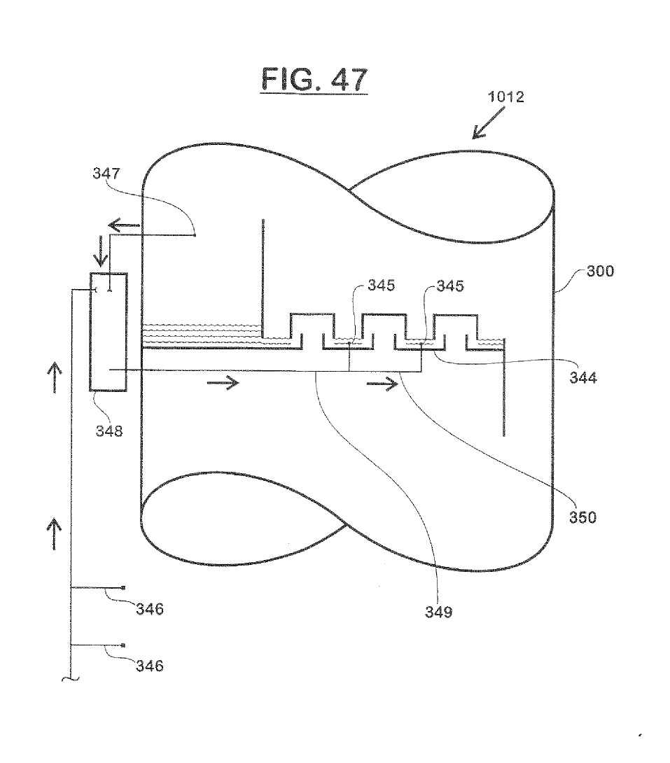

By device (1012) for variable control of micro and/or nano-bubbles flow by sparging in the bubbling liquid on a tray: FIG. 47 shows in side view a flexible device (1012), comprising a network of flexible ducts (349) that, from the vapor inlets (356, 347) through a variable control sparging compressor device (348), can reach by means of capillary extensions (350) in the tray (344) to capillary nozzles or needles (345) of micro- nanobubbles sparging flow, distributed in several points into the bubbling liquid on the upper trays surface (344), thus enabling mass transfer enhancing and variable control in real process time. This device (1012) can be combined with device (1010), so that, through said hatch in magazine (340), a tray being withdrawn by the magazine (340) can be manually quick disconnected from sparging flexible ducts (349) that can then be quick connected to a new inserting tray in the column (300).

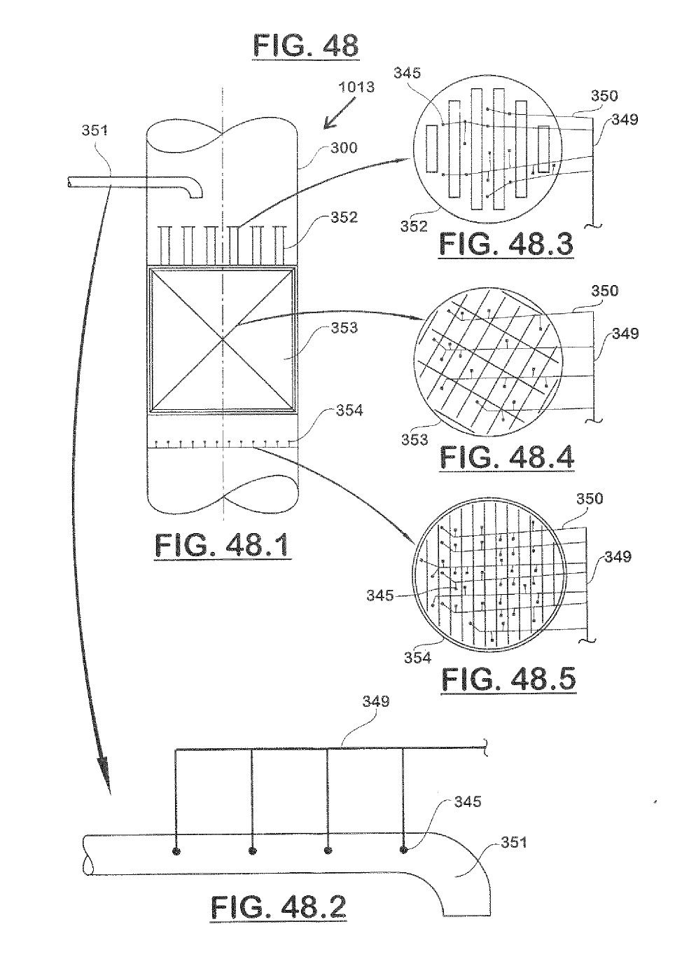

By device (1013), similarly to (1012) for variable control of a micro- and/or nano-bubbles flow by sparging of distillable vapor in the liquid present or bubbling in several columns internals: as exemplified in FIG. 48 a flexible device (1013), comprising a network of flexible ducts (349) that, from the vapor inlets (356, 347) through a variable control sparging compressor device (348), can reach by means of with said ducts (349) quick-connected capillary extensions (350) to capillary nozzles or needles (345) of micro-nanobubbles sparging flow, distributed in several internal column (300) components (FIG. 48.1) where liquid is present or bubbling, in particular: in the reflux inlet tube (351.19) (FIG. 48.2), in a liquid distributor (352, 17) (FIG. 48.3), in a packing (353, 15) (FIG. 48.4), and in a collector (354, 18) (FIG. 48.5), in the reflux inlet (351), in packings (353, 15), in liquid collectors (354, 18) and in liquid distributors (352, 17), being the variable control device fitted with electromechanical activation, which can be computerized and automated. The device (1013) can be combined with device (1011), so that, through mentioned hatches in a magazine (342), a packing being withdrawn from a column can be manually quick disconnected from sparging flexible ducts (349) that can then be quick connected to the capillary extensions (350) of a new inserting packing in the column

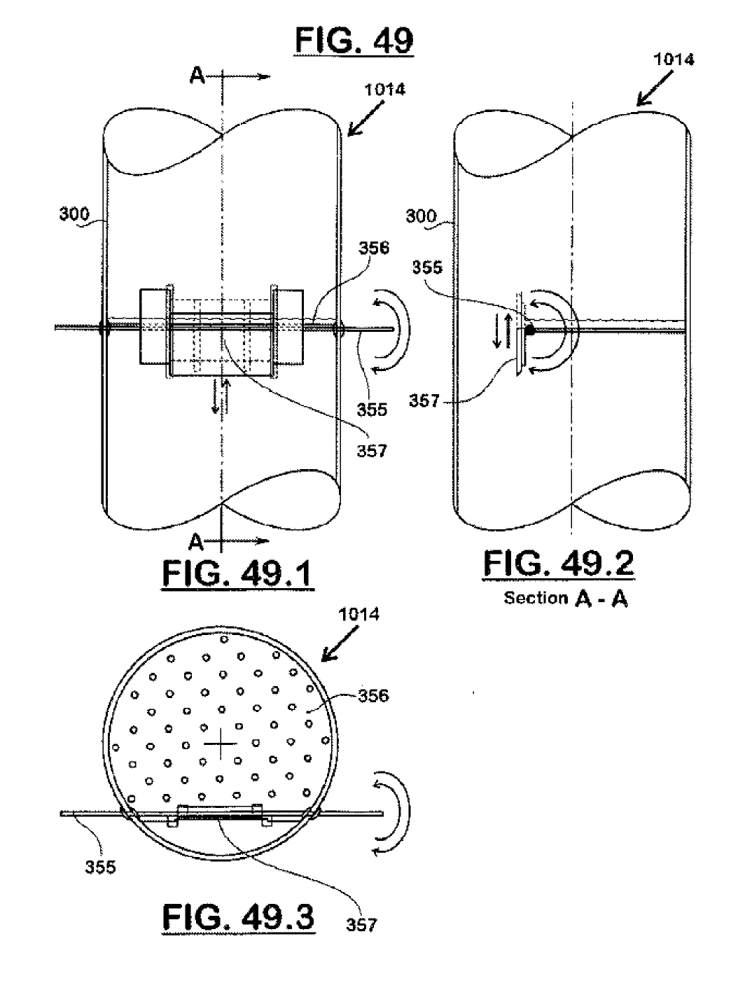

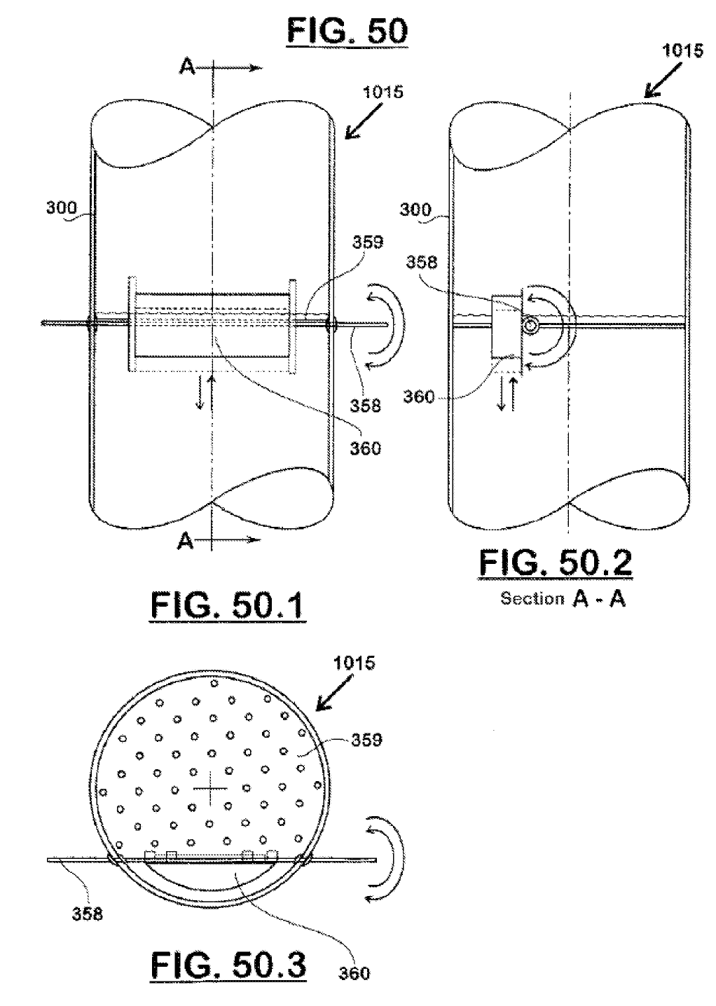

By device (1014) for variable control of the liquid level in a tray (356) or other column (300) internal component by varying the height of a flat weir of a downcomer (357): FIG. 49 shows in side view (FIG. 49.1), section A-A (FIG. 49.2) and in floor view (FIG. 49.3) a tray (356) (it can be any component fitted with a downcomer), whose downcomer (357) has a flat weir, which is mobile in the vertical direction by a swivel axis with motion transfer (355), or other conventional mechanism, with electromechanical control, which can be computerized and automated, thus controlling the liquid level in the tray or other component. By device (1015) for variable control of the level of liquid in trays (359) or other component of a distillation column (300) by variation of the height of a tubular weir, that is a tubular downcomer (360): FIG. 50 shows in side view (FIG. 50.1), section A-A (FIG. 50.2) and floor plan view (FIG. 50.3) a distillation tray (359), or another component whose tubular downcomer (360) has semi-circular, semi-elliptical or other type of tubular section, being the downcomer (360) mobile in the vertical direction by means a swivel axis with motion transfer (358), or other conventional mechanism, with electromechanical control, which can be computerized or automated, thus controlling the liquid level in the tray or other column component with a tubular downcomer.

### LIST OF NUMERIC REFERENCES OF THE FIGURES

Exemplifying Numeric References of the State of the Art:

11—Column A: for distilled raw ethanol

12—Column B: for distilled, rectified ethanol

13—Column C: for distilled, rectified, dehydrated ethanol

14—Perforated tray with bubble-caps or valves

15—Structured packing

16—Downcomer of a perforated tray

17—Liquid distributor

18—Liquid collector

19—Reflux inlet

20—Basic distillation column

Exemplifying Numeric References of the Invention:

1—Versatile Distillation Cell (illustrative diagram)

100—Sub-cell with rotating tower

101—Base of rotating tower

102—Prism of sub-cell with rotating tower

103—Modular column of sub-cell with rotating tower

104—Entire column of sub-cell with rotating tower

105—Entire column of sub-cell with rotating tower

106—Entire column of sub-cell with rotating tower

107—Module of column 103

108—Module of column 103

109—Module of column 103

110—Top of rotating tower

111—Support pads of sub-cell's platform

112—Hydraulid elevation system

113—Rotating block

114—Module of column (125) of sub-cell with rotating block

115—Reboiler

116—Assembling guide-tracks

117—Transfer guide-tracks

118—Transfer device for columns and modules among platforms

119—Mobile platform of sub-cell with rotating tower

120—Mobile platform of sub-cell with rotating block

121—Condenser

122—Cooler

123—Anterior support of rotating block

124—Posterior support of rotating block

125—Modular column of sub-cell with rotating block.

126—Rotating tower

127—Sub-cell with rotating block

200—Sub-cell with one modular articulated column

201—Mobile platform of articulated sub-cell

202—Junction and fixation flange

203—Hinge for articulated module

204—Sub-cell with articulated column with telescopic module

205—External telescopic module

206—Internal telescopic module

207—Articulated sub-cell with modules surrounded by structure

208—Module with external structure

209—Module with external structure

210—Module with external structure

211—Junction flange for modules with external structure

212—Vapor generator in structured column

213—Articulation hinges for modules with external structure

214—Handle or hook for lifting external structured columns

215—Lifting device

216—Articulated column

217—Articulated column with telescopic module

218—Articulated column with external structure

300—Column set (103 to 106, 125, 216 to 218) with internals

301—Horizontal gyratory axis of perforated tray

302—Gyratory perforated tray

303—Horizontal concentric axes of double folding trays

304—Upper folding perforated tray

305—Under folding perforated tray

306—Fixed concentric perforated tray

307—Rotating concentric perforated tray

308—Vertical gyratory axis of concentric perforated tray

309—Horizontal gyratory axis commanding vertical gyratory axis

310—Detail of perforated tray with fixed bubble-cap (valve)

311—Fixed bubble-cap (valve)of perforated tray

312—Mobile sealing of fixed bubble-cap of perforated tray

313—Spring shaft of the mobile sealing (312)

314—Solenoid for activation of spring shaft (313)

315—Detail of perforated tray

316—Individual hole of a tray (315)

317—his diaphragm for control of a hole's opening (316)

318—Solenoid (or other) activation rod of iris diaphragm (317)

319—Holes' set of a tray

320—Solenoid (or other) activation rod of iris diaphragm (321)

321—his diaphragm for control of the holes of a tray (319)

322—Downcomer of tray (319)

323—Detail of perforated tray

324—Individual hole of tray (323)

325—Pantographic grid for a hole's opening control (324)

326—Activation rod of pantographic grid (325)

327—Set of tray's holes

328—Pantographic grid for control of a tray's (327) holes' set

329—Activation rod of pantographic grid (328)

330—Mobile packing with vertical movement

331—Mobile tray with vertical movement

332—Vertical rod for tray (331) or packing (330) motion

333—Downcomer of a tray

334—Mobile tray with vertical movement

335—Vertical rod for tray (334) motion

336—Downcomer of a tray

337—Vertical rod for tray (331) or packing (330) motion

338—Vertical rod for tray (334) motion

339—Horizontal gyratory axes commanding concentric rods (337 and 338)

340—Magazine for quick-changeover of trays

341—Sliding hatch

342—Magazine for quick-changeover of packings

343—Packings for quick-changeover by magazine (342)

344—Perforate tray with bubbling liquid

345—Capillary nozzles or needles for sparging

346—Inlet of distillable material for sparging

347—Inlet of distillable material for sparging

348—Compressor system for sparging with variable control

349—Flexible capillary ducts

350—Extension of capillary duct

351—Reflux inlet

352—Liquid distributor of column (300)

353—Packing of column (300)

354—Liquid collector of column (300)

355—Horizontal gyratory axis for vertical movement of a downcomer's flat weir

356—Tray with downcomer with mobile flat weir (357)

357—Downcomer with flat weir

358—Horizontal gyratory axis for vertical movement of a downcomer's tubular weir (tubular downcomer) (360)

359—Tray with mobile tubular downcomer (360)

360—Tubular downcomer

1000—Set of references (301, 302) of turning tray “butterfly” type

1001—Set of references (303 a 305) of double folding tray “double butterfly” type

1002—Set of references (306 a 309) of concentric rotating tray

1003—Set of references (310 a 314) of adjustable sealing of fixed bubble-cap (valves)

1004—Set of references (315 a 318) of adjustable sealing of a tray's hole by “iris diaphragm”

1005—Set of references (319 a 322) of variable control of a tray's perforation openings by “iris diaphragm”

1006—Set of references (323 a 326) of variable control of an individual tray's hole by pantographic grid

1007—Set of references (327 a 329) of variable control of a tray's perforation openings by pantographic grid

1008—Set of references (330 a 336) of device for vertical motion of trays and packings

1009—Set of references (330, 331, 334, 337 a 339) of device for vertical movement of trays and packings activated by horizontal gyratory axis

1010—Set of references (340, 341) of magazine for quick changeover of trays (14)

1011—Set of references (341 a 343) of magazine for quick changeover of packings

1012—Set of references (344 a 349) of device for variable control of sparging of distillable material in trays

1013—Set of references (345, 349 a 354) of device for variable control of sparging of distillable material in: reflux inlet, packings, liquid distributors and collectors

1014—Set of references (355 a 357) of device for vertical movement of a downcomer with flat weir

1015—Set of references (358 a 360) of device for vertical movement of a tubular downcomer.

1-20. (canceled)

21. Versatile Distillation Cell (1), which introduces in distillation the “flexible manufacturing cell”, as an integrated set of multifunctional equipments with flexible components' forms and positioning, and improves this cell concept by combining quick relocation with rapidly modifiable distillation columns and on site adjustable liquid-vapor ratio in columns internals among diversified raw materials and final products, wherein the Cell (1) comprises a system of modular constructed distillation columns (103 to 106, 125, 216 to 218) of set (300) build up on by roads or other means mobile platforms (119, 120, 201), on which said columns can be easily fulfilled with internals fitted with variable geometry (301 to 360) of sets (1000 to 1015), being said columns arranged in two rotating sub-cells (100, 127) and three articulated sub-cells (200, 204, 207), for being quickly assembled, transported, elevated for real time adjustable distillation, lowered, disassembled, exchanged, structurally changed, internally re-fulfilled, and relocated.

22. Versatile Distillation Cell (1) as claimed in claim 21, being a rotating sub-cell (100) wherein it comprises, a rotating, elevating tower (126) made of steel or similar, with approximated form of a prism (102) of various faces, the prism being rotational in the horizontal position, with extremities attached to a rotating center of a base (101) and to a rotating center of a top (110) installed on a elevator (112) installed on a platform (119) mobile by road or other means, being said base (101) capable of a 90° turn movement around hinges (here not detailed) enabling elevation and fastening of the tower (126), so that said tower at the origin, in horizontal position, through partial rotations of the prism (102), can have attached at each prism's face a distillation column (104 to 106) or modules (107 to 109) of a column (103) where column internals (301 to 360) of sets (1000 to 1015) can be installed, thus forming a distillation system of various columns (11 to 13, 104 to 106) or including one or more independently operating columns (103); whereas by the prism (102) turning motions, the best angular position (around the tower axis) of the columns set for a specific distillation job or location can be pre-established and variably adjusted; being the tower (126) elevated for distillation, and afterwards lowered to the horizontal position where columns, modules and internals can be changed by each turn of the prism (102), or exchanged by means of devices (116, 117, 118) of a sub-cell (127), as below detailed.

23. Versatile Distillation Cell (1) as claimed in claim 21, being a rotating sub-cell (127) wherein it comprises a rotating block (113) made of steel or similar, with several faces of square, hexagonal or other section, which can rotate around a horizontal axis mounted on supports (123, 124) installed on a by roads or other means mobile platform (120), being by each partial rotation of the block (113), in the horizontal position, one module (107 to 109, 114) of a column (125) attached to one of the block faces, where this module can be quick and easily fulfilled with trays and other column internals (301 to 360) of sets (1000 to 1015), being the block with attached modules transported to destination, where at each partial rotation of the block (113) one module (107 to 109, 114) is lowered on assembly guide-tracks (116) on the platform (120), where said column internals can be inserted or exchanged, being modules aligned and fixed one to another by flanges (202, 211) to form a column (125), being the platform (120) fitted with an elevator (112), by which said column can be elevated for distillation and afterwards lowered; being installed on said platform transfer guide-tracks (117) and two transfer devices (118), in form of extend-retract-tilt crane arms, or similar, capable of three-dimensional movement for transferring modules (107 to 109, 114, 205, 206, 208 to 210) and columns (103 to 106, 125, 216 to 218) between platforms (119, 120, 201) of sub-cells (100, 127, 200, 204, 207).

24. Versatile Distillation Cell (1) according to claim 21, being an articulated sub-cell (200) wherein it comprises a distillation column (216) with modules (107 to 109) folded in variable positions by junction flanges (202) articulated by hinges (203) to be transported on a by road or other means mobile platform (201), fitted with elevator (112), by which said modules can be at destination unfolded and aligned to form a column (216) on said platform (201), where said modules, through open extremities or by quick changeover magazines (340, 342), can be rapidly filled with trays (14) packings (15), liquid distributors (17), liquid collectors (18) and other internals (301 to 360) of sets (1000-1015), whereas other distillation equipments as, for instance, a reboiler (115), a condenser (121) and a cooler (122) can be attached, being the column (216) elevated to distillation position, and afterwards lowered for internals changes or modules exchange by means of devices (116, 117, 118) of sub-cell (127) or for relocation.

25. Versatile Distillation Cell (1) as per claim 21, being a flexible sub-cell (204) wherein it comprises a column (217) composed of articulated modules (107, 108, 205, 206), which can be folded upon a by road or other means mobile platform (201) fitted with elevator (112), being at least one posterior module (206) inserted within the anterior module (205) from which it can be extended by telescopic movement (206), and fixed on anterior module's top (205) by a junction flange (202)or similar.

26. Versatile Distillation Cell (1) as per claim 21, being a flexible sub-cell (207) wherein it comprises a distillation column (218) with articulated modules (208 to 210) surrounded by metal structures fitted with hinges (213) and junction flanges (211) being said modules folded upon a by road or other means mobile platform (201) to be transported, being the upper module (210) equipped with handle or hook (214) to be lifted by crane or similar (215).

27. Versatile Distillation Cell (1) as claimed in claim 21, being fitted with a “butterfly type” folding tray (1000), for variable control of the vapor-liquid ratio in a tray (302) of a distillation column (300), wherein a rotational, perforated distillation tray (302), merely touches the wall of the downcomer (16), being the tray (302) fastened to a horizontal axis (301), which passes through its center and has its extremities attached to the wall of the distillation column (300), the rotation of the axis (301) and of the tray (302) being gradual or total, by electromechanical activation that can be computerized and automated.

28. Versatile Distillation Cell (1) as per claim 21 above, fitted with a “double folding butterfly”-type tray (1001) for variable control of vapor-liquid ratio in trays (304, 305) of a distillation column (300), wherein two superposed trays (304, 305) with different perforations merely touch the wall of the downcomer (16), being the trays (304, 305) respectively fastened to horizontal concentric revolving axes (303), whose ends are respectively attached to the column's (300) wall and to the downcomer's (16) wall, the axes' rotations having electromechanical, computerized or automated control, being each tray sectioned into two halves, the upper tray's (304) halves folding upwards and the under tray's (305) halves downwards, in micrometric gradation or completely up to 90° from the flat position.

29. Versatile Distillation Cell (1) as per claim 21, fitted with “perforated concentric trays” (1002) for variable control of vapor-liquid ratio in a tray (306) of a distillation column (300), wherein a perforated tray (307) with variable horizontal rotation is superposed by another fixed perforated tray (306), being the under tray (307) attached by its center to a vertical axis (308), which can rotate in micrometric gradation by command of a horizontal axis (309) with motion transfer, with electromechanical, computerized or automated actuation and control.

30. Versatile Distillation Cell (1) according to claim 21, fitted with a device (1003) for variable control of the vapor-liquid ratio in a tray (310), wherein a fixed bubble-cap or valve (311) of a tray (310) is fitted with an adjustable sealing (312), which is movable in the vertical direction by being attached to a spring rod (313) activated by a solenoid (314), with electromechanical, computerized or automated actuation and control.

31. Versatile Distillation Cell (1) according to claim 21 above, fitted with a device (1004) for variable control of the vapor-liquid ratio in a tray (315), wherein an adjustable sealing in a tray's (315) hole (316) is introduced through “iris diaphragm” (317) activated by solenoid (318) or other electromechanical, computerized or automated system.

32. Versatile Distillation Cell (1) according to claim 21, fitted with a device (1005) for variable control of vapor-liquid ratio in a tray (319) wherein adjustable control of the openings of a set of tray's (319) holes is provided by attaching at the under face of the tray (319) a “iris diaphragm” (321), activated by solenoid (320) or other electromechanical system, which can be computerized and automated.

33. Versatile Distillation Cell (1) as per claim 21 above, fitted with a device (1006) for variable control of vapor-liquid ratio in a tray (323) further comprising a grid attached at the opening of a tray's (323) hole (324), said grid being made of crisscrossed metal rods (or other compatible material), which can open and close by pantographic movement (325), activated by solenoid (326) or other electromechanical system, which can be computerized and automated.

34. Versatile Distillation Cell (1) according to claim 21, fitted with a device (1007) for variable control of vapor-liquid ratio in a tray (327) further comprising a grid attached at the under face of the tray (327), said grid being made of crisscrossed metal rods (or other compatible material), which can open and close by pantographic movement (328), activated by solenoid (329) or other electromechanical system, which can be computerized and automated.

35. Versatile Distillation Cell (1) according to claim 21, fitted with a device (1008) for variable control of vapor-liquid ratio in trays (331, 334) and in packings (330) of a distillation column (300), wherein two or more concentric, vertical mobile rods (332, 335, 337, 338) along a section of the internal central vertical line of a distillation column (300) can be respectively attached to the center of two or more trays (331, 334) or packings (330), so that by vertical movement of said rods' the distance between or among trays and/or packings can be gradually altered; being the rods' vertical movement.

36. Versatile Distillation Cell (1) according to claim 21, fitted with device (1010) for quick exchange of column trays (14) during brief distillation interval, wherein a magazine (340), containing various trays (14), is attached in front of a sliding hatch (341) at the side of a column (300), being the magazine fitted with quick-plugging/retract system enabling the withdrawing of a tray from the column and the insertion of a new tray into the free left space; being the to be exchanged trays fitted with quick-plugging slots or similar; being motions devices fitted with electromechanical activation and control, that can be computerized or automated.

37. Versatile Distillation Cell (1) according to claim 21, fitted with device (1011) for quick change of column packings (343), during brief distillation interval, further comprising a magazine (342) attached in front of a sliding hatch (341) at a column (300) side, the magazine (342) containing various packings (343), for instance separated in contiguous horizontal chambers disposed as a cross with three chambers around a central chamber, being the magazine fitted with quick-extend-retract system enabling the extraction or insertion of a column packing.

38. Versatile Distillation Cell (1) according to claim 21, fitted with sparging device (1012) for improvement and variable control of the vapor-liquid flow in a tray (344), further comprising a network of flexible ducts (349) leading, from a variable control device of micro-bubbles and/or nano-bubbles sparging (348), fitted with vapor inlets (346, 347), through capillary extensions (350) in the tray (344) to capillary nozzles or needles (345) distributed to points into the bubbling liquid on the tray's surface (344); being capillary ducts (349) optionally fitted with quick-plugging for manual quick-connect with exchanging trays.

39. Versatile Distillation Cell (1) according to claim 21, fitted with sparging device (1013) for improvement and variable control of the vapor-liquid flow in several column (300) components, further comprising a network of flexible ducts (349) leading, from the variable control device of micro-bubbles and/or nano-bubbles sparging (348), through capillary extensions (350) to capillary nozzles or needles (345) distributed to several points into the liquid present or bubbling in the reflux inlet (351), in packings (353, 13), in liquid collectors (354, 18) and in liquid distributors (352, 17); the capillary ducts (349) being optionally fitted with quick-plugging for manual quick-connect with exchanging packings.

40. Versatile Distillation Cell (1) according to claim 21 above, fitted with devices (1014) (1015) for variable control of the liquid level in a tray (356, 359) or an internal column component fitted with a flat-weir (357) (1014) or a tube-weir (360) (1015) downcomer, wherein the flat- or tube-weir of a downcomer (357, 360) is fitted with gradual micrometric vertical slide movement along parallel guides with command of a rotating axis (355, 358) with electromechanical activation, which can be computerized or automated.
